(19) United States
(12) Patent Application Publication
(10) Pub. No.: US 2024/0132679 A1
(43) Pub. Date: Apr. 25, 2024

(54) FILLER-CONTAINING THERMOPLASTIC POLYMER COMPOSITE MATERIAL REINFORCED WITH CONTINUOUS FIBERS AND HAVING GOOD SURFACE SMOOTHNESS

(71) Applicant: INEOS STYROLUTION GROUP GMBH, Frankfurt am Main (DE)

(72) Inventors: Felix KLAUCK, Madrid (ES); Pierre JUAN, Frankfurt am Main (DE); Norbert NIESSNER, Friedelsheim (DE); Eike JAHNKE, Frankfurt am Main (DE); Andre LUECK, Wendelstein (DE); Florian PIOTT, Erlangen (DE); Dietmar DRUMMER, Wendelstein (DE); Leo HOFFMANN, Fuerth (DE)

(21) Appl. No.: 18/257,581

(22) PCT Filed: Dec. 14, 2021
(86) PCT No.: PCT/EP2021/085643

§ 371 Date: Jun. 14, 2023

(30) Foreign Application Priority Data
Dec. 16, 2020 (EP) 20214722.9

(51) Int. Cl. C08J 5/04; C08K 3/26; C08K 5/103; C08K 7/14; C08K 7/28

(52) U.S. Cl. CPC C08J 5/043; C08K 3/26; C08K 5/103; C08K 7/14; C08K 7/28; C08J 2323/16; C08J 2451/06; C08K 2003/265

(57) ABSTRACT

The invention relates to composite materials (organosheets) containing a thermoplastic molding compound, at least one continuous reinforcing fiber layer and at least one inorganic filler material. According to the invention, a sheet material consisting of continuous reinforcing fibers in a matrix composition comprising the molding compound is used, the thermoplastic molding compound containing at least one polyolefin, and optionally at least one further, polarity-functionalized polymer. The invention also relates to a process for produci2023ng the claimed composite material and to uses thereof.

The present invention relates to composite materials (organosheets) comprising a thermoplastic molding compound, at least one layer of continuous reinforcing fibers and at least one inorganic filler. In particular, at least one sheetlike structure consisting of continuous reinforcing fibers is embedded into a matrix composition comprising the thermoplastic molding compound, where the thermoplastic molding compound comprises at least one polymer, especially at least one polyolefin, and optionally at least one further, polar-functionalized polymer. The invention additionally relates to a process for producing the composite material of the invention and to uses thereof.

### PRIOR ART

Composite materials or organosheets frequently consist of a multitude of reinforcing fibers embedded in a polymer matrix. Composite materials have various fields of use. For example, composite materials are used in the transportation and aviation sector. The use of composite materials here is intended to prevent the breakup or other fragmentation of the component in order thus to reduce the risk of accidents resulting from individual component fragments. Many composite materials are capable of absorbing comparatively high forces under stress before total failure. Total failure in the case of fiber-reinforced composite materials is manifested in that components, for example in the case of flexural stress, on exceedance of the maximum bending stress, rather than bursting apart into many individual components when they fracture, remain coherent via the reinforcing fibers with individual fractures or cracks. At the same time, composite materials are notable for high strength and stiffness, adjustable in a direction-dependent manner, with simultaneously low density and further advantageous properties, for example good aging resistance and corrosion resistance.

Strength and stiffness of the composite materials may be matched to the direction of stress and type of stress.

It is the fibers that are primarily responsible here for the strength and stiffness of the composite material. Moreover, the arrangement thereof often also determines the direction-dependent mechanical properties of the respective composite material. The matrix serves primarily to introduce the forces to be absorbed into the individual fibers and to maintain the spatial arrangement of the fibers in the desired orientation. In addition, the matrix protects the fibers from outside influences and determines the long-term properties of the composite material. But in particular, the choice of matrix material to a high degree determines the outward appearance of the composite material.

In the production of composite materials, in particular, the bonding of fibers and polymer matrix to one another and the critical fiber length play a major role. The strength of the embedding of the fibers into the polymer matrix (fiber-matrix adhesion) can also have a considerable influence on the properties of the composite material. In addition, the process for producing the materials should be performable easily and inexpensively.

Since both the fibers and the matrix materials can be varied, there are numerous possible combinations of fibers and matrix materials. It is often the case, because of the low chemical similarity between the fiber surface and the surrounding polymer matrix, that there is low attraction and hence low adhesion between fibers and matrix materials.

In order to optimize fiber-matrix adhesion, and in order to compensate for low chemical similarity between the components, reinforcing fibers are regularly pretreated with a size (sizing agent). Such a size (sizing agent) is often applied to the fiber during production in order simultaneously to improve the further processibility of the fibers (such as weaving, laying, sewing). In some cases, reinforcing fibers, for example glass fibers, are also processed in unsized form. It is often the case that these glass fiber sizes comprise a large number of different components, such as, in particular, film formers, lubricants, wetting agents and adhesion promoters.

The treatment of reinforcing fibers with a size serves, inter alia, to prevent damage to the fibers through abrasion or to facilitate the operation of cutting the fibers.

In addition, the size can prevent agglomeration of the fibers and improve the dispersibility of fibers in water. However, a size can also contribute to establishing improved cohesion between the glass fibers and the polymer matrix in which the glass fibers act as reinforcing fibers. This principle is applied particularly in the case of glass fiber-reinforced composite materials. Typically, adhesion promoters in the size can increase the adhesion of polymers on the fiber surface, in that they form a bridging layer between the two surfaces.

It is often the case that organofunctional silane compounds, for example aminopropyltriethoxysilane, methacryloyloxypropyltrimethoxysilane, glycidyloxypropyltrimethoxysilane and the like, are used.

A technical challenge is to prevent material fracture in the event of total failure of the fiber-reinforced composite materials, since this can result in a considerable risk of accident from torn components. This is problematic, for example, in the case of components that are subject to high stress.

It is therefore desirable to provide composite materials having lower intrinsic weight and a wide load range, where total failure is not manifested in the form of material fracture. Additionally desirable are composite materials having excellent optical properties, such as smooth and/or shiny surfaces. In order to obtain an esthetically high-quality surface, specifically in composite materials having a semicrystalline thermoplastic matrix, it is crucial to achieve a reduction in the shrinkage of the thermoplastic matrix, for example on cooling after production of the composite material.

WO 2008/058971 describes molding compounds that use various groups of reinforcing fibers. The groups of reinforcing fibers are each provided with different adhesion promoter components that are intended to bring about different fiber-matrix adhesions. Suggested matrix materials are thermosets, such as polyester, and thermoplastics, such as polyamide and polypropene. The aim of the invention is to achieve improved performance in respect of fracture mechanics in the event of total failure.

Application WO 2010/074120 describes a fiber-reinforced polypropene-resin composition comprising a reinforcing fiber, a largely unmodified polypropene resin and two further polypropene resins comprising a carboxy-modified polypropene resin, where the molecular weight of the various polypropene resins is defined. The aim here is to achieve very advantageous fiber-matrix adhesion, in order to optimize the mechanical properties of the composite material. In the application, this is achieved via an adjustment of the ratios of the two functional monomers.

Application WO 2019/086431 describes a fiber-reinforced composition, characterized in that a filler that remains in an outer region with respect to the fiber bundles and hence reduces the shrinkage of the matrix is present. The resin composition can be found both in the outer region with the fillers and in the inner region of the fiber bundles.

Glass fiber-reinforced polypropene resins are also described in CN-A 102 558685, CN-A 102 911433, CN 102924815, CN-A 103788470, CN-A 103819811, CN-A 104419058, CN-A 103772825, WO 2016/101139, WO 2016/154791, CN-A 107 815013, CN-A 107 118437, WO 2019/010672 and CN-A 108164822.

WO 2008/119678 discloses thermoplastic molding compounds comprising 5% to 95% of a copolymer A consisting of: 70-76% vinylaromatic monomer A1, 24-30% vinyl cyanide monomer component A2 and 0-50% of one or more unsaturated copolymerizable monomers A3; 0-60% of a graft rubber B and 5-50% glass fibers C. The molding compounds are produced by mixing the components and processed by the injection molding method.

Application WO 2016/170145 describes a process for producing thermoplastic fiber composite material consisting of a) 30% to 95% by weight of a thermoplastic matrix M, b) 5% to 70% by weight of a reinforcing fiber B, and c) 0% to 40% by weight of an additive C. Additives disclosed are particulate mineral fillers, processing aids, stabilizers, antioxidants, agents to counter thermal decomposition and decomposition by ultraviolet light, lubricating and demolding agents, flame retardants, dyes and pigments and plasticizers.

WO 2016/170148 discloses a process for producing a thermoplastic fiber composite material comprising a) 30% to 95% by weight of a thermoplastic molding compound A as polymer matrix, b) 5% to 70% by weight of a sheetlike structure G composed of reinforcing fibers B, and c) 0% to 40% by weight of an additive C. Additives mentioned are particulate mineral fillers, processing aids, stabilizers, antioxidants, agents to counter thermal decomposition and decomposition by ultraviolet light, lubricating and demolding agents, flame retardants, dyes and pigments and plasticizers.

WO 2016/170131 teaches a fiber composite material with a foam component in the form of a solid lightweight sandwich structure. The fiber composite material comprises a thermoplastic molding compound A and at least one layer of reinforcing fibers B. The at least one layer of reinforcing fibers B is embedded into the matrix comprising the thermoplastic molding compound A, where the thermoplastic molding compound A includes at least one chemically reactive functionality. The fiber composite material has a further thermoplastic layer T and/or at least one foam layer S and is suitable for production of moldings. Additives may optionally be included, such as particulate mineral fillers, processing aids, stabilizers, antioxidants, agents to counter thermal decomposition and decomposition by ultraviolet light, lubricating and demolding agents, flame retardants, dyes and pigments and plasticizers.

WO 2016/170098 discloses the use of a fiber composite material for production of transparent or translucent shaped bodies, films and coatings. The fiber composite material comprises a thermoplastic molding compound A as matrix and at least one layer of reinforcing fibers B, where the at least one layer of reinforcing fibers B is embedded into the matrix comprising the thermoplastic molding compound A, and where the thermoplastic molding compound A includes at least one chemically reactive functionality. Additives may optionally be included, such as particulate mineral fillers, 10 processing aids, stabilizers, antioxidants, agents to counter thermal decomposition and decomposition by ultraviolet light, lubricating and demolding agents, flame retardants, dyes and pigments and plasticizers.

WO 2016/170104 relates to the use of a fiber composite material in the white goods sector.

The fiber composite material comprises a thermoplastic molding compound A and a reinforcing fiber B, where the layers of the reinforcing fiber B are embedded into a polymer matrix composed of the thermoplastic molding compound A, and where the thermoplastic molding compound A includes at least one chemically reactive functionality. Optional additives disclosed are particulate mineral fillers, processing aids, stabilizers, antioxidants, agents to counter thermal decomposition and decomposition by ultraviolet light, lubricating and demolding agents, flame retardants, dyes and pigments and plasticizers.

DE 69831854 (T2) discloses a glass mat (GMT) material into which fillers are embedded, having improved properties over similar nonfilled GMT composite materials. The filled thermoplastic glass mat (GMT) composite material comprises a polyolefin; glass fibers having a glass fiber length of at least about 6.4 mm (1/4 inch); and a mineral filler, where the filler is selected from the group consisting of fiberglass, kaolin, mica, wollastonite, calcium carbonate, talc, precipitated calcium carbonate, barium sulfate, MoS₂, ferrite, iron oxide, hollow beads, aluminum trihydrate (ATH), Mg(OH)₂, TiO₂, ZnO, barytes, satin white, iron oxide, metal powder, oxides, chromates, cadmium, fumed silica, glass beads and basic lead silicate.

DE 202017004083 U1 describes a semifinished fiber-matrix product which comprises a core of semifinished fiber layers impregnated with at least one matrix component, preferably comprising polyamide or polypropene, and at least one outer layer of a high-viscosity tough film which is used like a thermoforming film in the forming of the component, which means that pores that can arise in the forming of conventional semifinished fiber-matrix products can be avoided or closed.

The matrix component may optionally comprise fillers and/or reinforcers selected from the group of mica, silicate, quartz, wollastonite, kaolin, amorphous silicas, mesoscale minerals, especially montmorillonites or nanoboehmite, magnesium carbonate, chalk, feldspar, barium sulfate, glass beads, ground glass and/or fibrous fillers and/or reinforcers based on carbon fibers and/or glass fibers.

EP-A 0945253 describes a filled thermoplastic glass mat composite material (GMT) comprising a polyolefin, glass fibers and a filler. The filled GMT composite material has mechanical properties similar to those of unfilled GMT composite materials. The preferred polyolefins include polypropene mixtures, polyethene mixtures, polymethylpentene mixtures and copolymer mixtures thereof. The glass fibers are longer than 6.4 mm (1/4 inch) and preferably have a length of at least 12.7 mm (1/2 inch). The glass fibers may be continuous glass mats, such as unidirectional or random mats and woven or nonwoven mats or chopped fibers. The filler is selected from mineral, synthetic or vegetable sources, and is preferably selected from mica, talc, calcium carbonate and barium sulfate.

EP-A 3394171 describes a fiber-reinforced polypropene composition with reduced weight and retained mechanical properties, and articles formed therefrom. The fiber-reinforced polymer composition comprises
(a) 10% to 85% by weight, based on the total weight of the fiber-reinforced polymer composition, of a polypropene (PP),
(b) 12.5% to 53% by weight, based on the total weight of the fiber-reinforced polymer composition, of the fibers (F),
(c) 2% to 12% by weight, based on the total weight of the fiber-reinforced polymer composition, of glass bubbles (GB) and
(d) 0.5% to 5% by weight, based on the total weight of the fiber-reinforced polymer composition, of a polar-functionalized polypropene (PMP) as adhesion promoter.

Fibers F used are preferably chopped glass fibers, also known as short fibers or chopped strands. The polymer composition may be processed to shaped articles, preferably injection-molded articles or foam articles.

DE 10 2017125438 describes a fiber-reinforced composite material comprising a fiber material having multiple continuous fibers each formed from filaments, a matrix material made of plastic that fills an inner spatial region between the filaments of a particular continuous fiber and surrounds the continuous fibers in an outer spatial region, and an amount of particles. The particles preferably comprise glass particles, especially hollow glass bodies, and/or carbon particles and/or mineral particles and/or ceramic particles and/or thermally expanding and/or pressure-expanding particles.

WO 2019/086431 discloses a fiber-reinforced composite material comprising a fiber material having multiple continuous fibers each formed from filaments, a matrix material made of plastic that fills an inner spatial region between the filaments of a particular continuous fiber and surrounds the continuous fibers in an outer spatial region, and an amount of particles. The particles are preferably selected from glass particles, especially hollow glass bodies, and/or carbon particles and/or mineral particles and/or ceramic particles, or consist thereof. A first volume concentration of the particles based on the matrix material in the inner spatial region is smaller than a second volume concentration of the particles based on the matrix material in the outer spatial region, where the second volume concentration is homogeneous, and the second volume concentration in the outer spatial region is matched to a volume concentration, based on the matrix material, of the filaments in the inner spatial region such that temperature-dependent material properties of the composite material in the outer spatial region and in the inner spatial region match one another. Preferably, the first concentration and the second volume concentration are chosen such that a temperature-specific coefficient of expansion of the composite material in the inner spatial region differs by not more than 15% from a temperature-specific coefficient of expansion of the composite material in the outer spatial region.

WO 2018/114979 teaches a vehicle interior part produced from a thermoplastic composition, comprising from 48% to 95% by weight, based on the weight of the composition, of at least one heterophasic propylene copolymer, where the heterophasic propylene copolymer consists of i) a propylene-based matrix consisting of a propylene homopolymer and/or a propylene-α-olefin copolymer, where the matrix consists of at least 90% by weight of propylene and at most 10% by weight of α-olefin, based on the total weight of the propylene-based matrix, and ii) a dispersed ethylene-α-olefin copolymer comprising ethylene and at least one C3 to C10 α-olefin; —from 0% to 20% by weight, based on the weight of the composition, of an ethylene-α-olefin elastomer comprising ethylene and at least one C3 to C10 α-olefin; —optionally >5% to 15% by weight, based on the weight of the composition, of a high-density polyethylene (HDPE); —from 1% to 30% by weight, based on the weight of the composition, of talc, having a high aspect ratio as filler; —from 0% to 5% by weight, based on the weight of composition, of another talc; —from 0.05% to 1% by weight, based on the weight of the composition, of a phenolic antioxidant additive; —from 0.05% to 1% by weight, based on the weight of the composition, of at least one amphiphilic protection additive, comprising a hydrophilic moiety and a hydrophobic moiety; and —from 0% to 3% by weight, based on the weight of the composition, of one or more additional additives.

It is an object of the invention to provide an improved fiber-reinforced composite material based on a thermoplastic (co)polymer that has good strength and high surface quality (i.e. low surface corrugation), and is resistant to stress cracking and solvents. Moreover, the composite material is to be suitable for production of moldings, films and coatings. In addition, the production of the composite material is to be possible inexpensively and in a standard method with minimum cycle times.

It has been found that, surprisingly, a fiber-reinforced composite material having the abovementioned properties can be obtained in that compensation for shrinkage can be achieved by introducing a filler into a thermoplastic matrix polymer and impregnating the textile fibers, and the measured surface corrugation of the fiber-reinforced composite material thus obtained can be reduced significantly.

In addition, surprisingly, a production process for such a thermoplastic fiber-reinforced composite material has been found. If both the thermoplastic molding compound and the filler are supplied in the form of powder, lumps of caked powder form on the compression mold in conventional production methods, which can impair the lifetime of the compression mold. The introducing of the thermoplastic molding compound and of the filler in the form of a thermoplastic film, or, alternatively, the introducing of the thermoplastic molding compound as a thermoplastic film and of the filler in the form of a powder which is supplied beneath the thermoplastic film, can completely avoid lumps of caked powder on the compression mold.

The present invention relates to a fiber-reinforced thermoplastic composite material V comprising (or consisting of):
a) ≥5% to <20% by weight, preferably ≥7% to ≤18% by weight, of a thermoplastic molding compound A, where the thermoplastic molding compound A comprises at least one thermoplastic polymer A1, preferably at least one polyolefin, and optionally at least one polar-functionalized polymer A2 comprising repeat units of at least one functional monomer A2-I;
b) ≥20% to ≤80% by weight, preferably ≥50% to ≤80% by weight, of at least one continuous reinforcing fiber B in the form of filament bundles, comprising a multitude of filaments, preferably selected from inorganic or organic reinforcing fibers, especially preferably selected from glass fibers and/or carbon fibers, more preferably from glass fibers;
c) ≥1% to ≤60% by weight, preferably ≥3% to ≤45% by weight, of at least one particulate inorganic filler C, preferably selected from glass fillers, mineral fillers, ceramic fillers and mixtures thereof, and
d) ≥0% to ≤10% by weight, preferably ≥0.01% to ≤10% by weight, further preferably ≥0.1% to ≤5% by weight, of at least one further additive D, preferably selected from processing auxiliaries, stabilizers, lubricants and demolding agents, flame retardant, dyes, pigments and plasticizers;
   wherein the at least one particulate inorganic filler C has a coefficient of linear thermal expansion α_{C} (CLTE, measured according to ISO 11359-1 and ISO 11359-2) which is lower than the coefficient of linear thermal expansion α_{A} of the thermoplastic molding compound A (likewise measured according to ISO 11359-1 and ISO 11359-2), i.e. the following relationship (I) is applicable:

α_{C}<α_{A} (I);

where the at least one particulate inorganic filler C has a volume shrinkage which is 0.1 to 2 times the volume shrinkage of the continuous reinforcing fibers B, where the volume shrinkage is found from the coefficient of thermal volume expansion α_{V} in 1/K of the respective component multiplied by the proportion by weight of the respective component in the composite material V in % by weight/100 and by the reciprocal density of the respective component in g/cm³, according to the following relationship (II):

$$\frac{{∝}_{V , C} \times proportion of C \times density of B in g / ml}{{∝}_{V , B} \times proportion of B \times density of C in g / ml} = 0.1 to 2 \qquad ( II )$$

with
α_{V,C}=coefficient of thermal volume expansion of component C in 1/K,

proportion of C=proportion by weight of component C in the overall composite material V in % by weight/100,
α_{V,B}=coefficient of thermal volume expansion of component B in 1/K,

proportion of B=proportion by weight of component B in the overall composite material V in % by weight/100;

and where the following relationships are applicable:

α_{V,C}=3*α_{C}; and

α_{V,C} =3*α_{B}

with
=average coefficient of linear thermal expansion of component A;
α_{B}=average coefficient of linear thermal expansion of component B; and
α_{C}=average coefficient of linear thermal expansion of component C;
   and where the figures in % by weight are each based on the overall fiber-reinforced thermoplastic composite material V, and the sum total of components A, B, C and D is 100% by weight.

In the context of the present invention, the coefficient of linear thermal expansion a (CLTE) is determined according to ISO 11359-2 (especially ISO 11359-2:1999); the general fundamentals of the thermochemical test methods are described in ISO 11359-1 (especially ISO 11359-2:2015). Typically, the coefficient of linear thermal expansion a (especially the average coefficient of linear thermal expansion a) is found in 1/K according to the following relationship (III):

$$α = \frac{Δ L}{Δ T} = \frac{1}{{L}_{0}} \qquad ( III )$$

with
ΔL=change in length of the test sample between two temperatures T₁ and T₂;
ΔT=change in temperature (=T₂−T₁);
L₀=reference position of the sample at room temperature in the direction of measurement.

The size and position of the temperature range ΔT are typically chosen according to standards ISO 11359-1,2. Typically, the coefficient of thermal expansion is determined within a temperature range ΔT in the range from −30 to 200° C., especially 40 to 150° C., especially 70 to 120° C.

Typically, the coefficient of thermal volume expansion av is obtained by replacing the expression “length” with “volume” in equation (III). By way of approximation, it can be assumed that the coefficient of thermal volume expansion α_{V} corresponds to three times the coefficient of linear thermal expansion α (α_{A}=3*α). The coefficient of linear thermal expansion a used is often a value averaged over two or three of the dimensions of the test sample.

In the context of the present invention, the volume shrinkage of the at least one filler C is found according to:

ΔV_{C}=α_{V,C}* proportion by weight of component C in the overall composite material V in % by weight/100/density of component C in g/cm³; where, approximately, α_{V,C}=3*α_{C}.

In the context of the present invention, the volume shrinkage of the at least one continuous reinforcing fiber B is found according to:

ΔV_{B}=α_{V,B}* proportion by weight of component B in the overall composite material V in % by weight/100/density of component B in g/cm³; where, approximately, α_{V,B}=3*α_{B}.

In embodiments in which the optional component D is present, it is especially possible to adjust the proportion of the thermoplastic molding compound A correspondingly, such that the sum total of components A, B, C and D adds up to and does not exceed 100% by weight.

In a preferred embodiment, the portions of component A, B, C and optionally D add up to 100% by weight.

A preferred embodiment of the invention relates to a fiber-reinforced thermoplastic composite material V comprising (preferably consisting of):
a) ≥5% to <20% by weight, preferably ≥7% to ≤18%, by weight of a thermoplastic molding compound A, where the thermoplastic molding compound A comprises at least one thermoplastic polymer A1, preferably at least one polyolefin, and optionally at least one polar-functionalized polymer A2 comprising repeat units of at least one functional monomer A2-I; and where the at least one polyolefin is selected from homo- or copolymers of ethene, propene, butene and/or isobutene, and where the polar-functionalized polymer A2 is a copolymer of at least one repeat unit A2-I and at least one repeat unit A2-II, where the at least one repeat unit A2-I is selected from maleic anhydride, N-phenylmaleimide, tert-butyl (meth)acrylate, glycidyl (meth)acrylate and mixtures thereof, and the at least one repeat unit A2-II is selected from ethene, propene, butene, isobutene and mixtures thereof;
b) ≥20% to ≤80% by weight, preferably ≥50% to ≤80% by weight, of at least one continuous reinforcing fiber B in the form of filament bundles, comprising a multitude of filaments, preferably selected from inorganic or organic reinforcing fibers, especially selected from glass fibers and/or carbon fibers, more preferably from glass fibers;
c) ≥1% to ≤60% by weight, preferably ≥3% to ≤45% by weight, of at least one particulate inorganic filler C, preferably selected from glass fillers, mineral fillers, ceramic fillers and mixtures thereof, and
d) ≥0% to ≤10% by weight, preferably ≥0.1% to ≤5% by weight, of at least one further additive D,
   where the following relationships (I) and (II) are applicable:

α_{C}<α_{A} (I)

$$\frac{{∝}_{V , C} \times proportion of C \times density of B in g / ml}{{∝}_{V , B} \times proportion of B \times density of C in g / ml} = 0.1 to 2 \qquad ( II )$$

with:
α_{V,C}=coefficient of thermal volume expansion of component C in 1/K,

proportion of C=proportion by weight of component C in the overall composite material V in % by weight/100,
α_{V,B}=coefficient of thermal volume expansion of component B in 1/K,

proportion of B=proportion by weight of component B in the overall composite material V in % by weight/100;

and where the following relationships are applicable:

α_{V,C}=3*α_{C}; and

α_{V,B}=3*α_{B}

with:
α_{A}=average coefficient of linear thermal expansion of component A;
α_{B}=average coefficient of linear thermal expansion of component B; and
α_{C}=average coefficient of linear thermal expansion of component C;
   and where the figures in % by weight are each based on the overall fiber-reinforced thermoplastic composite material V, and the sum total of components A, B, C and D is 100% by weight.

An alternative preferred embodiment of the invention relates to a fiber-reinforced thermoplastic composite material V comprising (preferably consisting of):
a) ≥5% to <20% by weight, preferably >10% to ≤18% by weight, of a thermoplastic molding compound A, where the thermoplastic molding compound A comprises at least one thermoplastic polymer A1, preferably at least one polyolefin, and optionally at least one polar-functionalized polymer A2 comprising at least one functional monomer A2-I;
b) ≥50% to ≤80% by weight, preferably ≥50% to ≤60% by weight, of at least one continuous reinforcing fiber B in the form of filament bundles, comprising a multitude of filaments;
c) ≥20% to ≤45% by weight, preferably ≥30% to ≤40% by weight, of at least one inorganic mineral filler C, preferably selected from inorganic carbonates, more preferably calcium carbonate, and
d) ≥0% to ≤10% by weight, preferably ≥0.1% to ≤5% by weight, of at least one further additive D,
   where:

α_{C}<α_{A}

and

$$\frac{{∝}_{V , C} \times proportion of C \times density of B in g / ml}{{∝}_{V , B} \times proportion of B \times density of C in g / ml} = 0.1 to 2$$

with
α_{V,C}=coefficient of thermal volume expansion of component C in 1/K,

proportion of C =proportion by weight of component C in the overall composite material V in % by weight/100,
α_{V,B}=coefficient of thermal volume expansion of component B in 1/K,

proportion of B=proportion by weight of component B in the overall composite material V in % by weight/100;

and where the following relationships are applicable:

α_{V,C}=3*α_{C}; and

α_{V,B}=3*α_{B}

with α_{A}=average coefficient of linear thermal expansion of component A;

α_{B}=average coefficient of linear thermal expansion of component B; and

α_{C}=average coefficient of linear thermal expansion of component C;

and where the figures in % by weight are each based on the overall fiber-reinforced thermoplastic composite material V, and the sum total of components A, B, C and D is 100% by weight.

A further alternative preferred embodiment of the invention relates to a fiber-reinforced thermoplastic composite material V comprising (preferably consisting of):
a) ≥5% to <20% by weight, preferably ≥10% to ≤20% by weight, of a thermoplastic molding compound A, where the thermoplastic molding compound A comprises at least one thermoplastic polymer A1, preferably at least one polyolefin, and optionally at least one polar-functionalized polymer A2 comprising at least one functional monomer A2-I;
b) ≥50% to ≤80% by weight, preferably ≥70% to ≤80% by weight, of at least one continuous reinforcing fiber B in the form of filament bundles, comprising a multitude of filaments;
c) ≥1% to ≤20% by weight, preferably ≥3% to ≤10% by weight of at least one inorganic glass filler C, especially hollow glass bodies, and
d) ≥0% to ≤10% by weight, preferably ≥0.1% to ≤5% by weight, of at least one further additive D,
   where the following relationships (I) and (II) are applicable:

α_{C}<α_{A} (I)

$$\frac{{∝}_{V , C} \times proportion of C \times density of B in g / ml}{{∝}_{V , B} \times proportion of B \times density of C in g / ml} = 0.1 to 2 \qquad ( II )$$

with:
α_{V,C}=coefficient of thermal volume expansion of component C in 1/K,

proportion of C =proportion by weight of component C in the overall composite material V in % by weight/100,
α_{V,B}=coefficient of thermal volume expansion of component B in 1/K,

proportion of B=proportion by weight of component B in the overall composite material V in % by weight/100;

and where the following relationships are applicable:

α_{V,C}=3*α_{C}; and

α_{V,B}=3*α_{B}

with α_{A}=average coefficient of linear thermal expansion of component A;
α_{B}=average coefficient of linear thermal expansion of component B; and
α_{C}=average coefficient of linear thermal expansion of component C;
and where the figures in % by weight are each based on the overall fiber-reinforced thermoplastic composite material V, and the sum total of components A, B, C and D is 100% by weight.

It is preferably a feature of the composite material V that the thermoplastic molding compound A penetrates into the filament bundle of the continuous reinforcing fibers B, but the fillers C penetrate only to an extent of not more than 10% into the filament bundle of the continuous reinforcing fibers B, based on area proportions of a cross section of the filament bundles. This is assured by a suitable selection of the fillers, and leads to enrichment of the fillers C in the regions of the molding compound A between the continuous reinforcing fibers B. On the other hand, only small amounts of filler C are found within the continuous reinforcing fibers B, i.e. between the individual filaments of a filament bundle.

The filler C is additionally present virtually exclusively in the outer region of the filament bundles, i.e. within a range of up to 10% of the diameter of an individual filament bundle.

Suitable analysis methods for this purpose are especially electron microscopy or reflected light microscopy on the cross-sectional areas of the continuous reinforcing fibers B in the composite material V.

### Thermoplastic Molding Compound A

The composite material V contains at least 5% by weight, generally at least 7% by weight, based on the total weight of the composite material V, of the thermoplastic molding compound A. The composite material V contains <20% by weight, generally not more than 18% by weight, based on the total weight of the composite material V, of the thermoplastic molding compound A.

The thermoplastic molding compound A is present in the composite material V at from 5% to <20% by weight, preferably from 7% to 18% by weight, especially 10% to 18% by weight, based on the composite material V.

The thermoplastic molding compound A is preferably present in the composite material V at from 5% to 50% by volume, preferably from 10% to 40% by volume and especially preferably from 15% to 35% by volume, based on the composite material V.

The thermoplastic molding compound A comprises at least one thermoplastic polymer A1. A thermoplastic polymer A1 is preferably an amorphous or semicrystalline polymer. A thermoplastic polymer A1 is preferably an amorphous or semicrystalline polymer selected from polystyrenes (PS), styrene/acrylonitrile copolymers (PSAN), acrylonitrile/butadiene/styrene copolymers (ABS), acrylate/styrene/acrylonitrile copolymers (ASA), polycarbonates, such as polycarbonate is based on bisphenol A, polyesters, polyamides, such as nylon-6 and nylon-6,6, polyolefins, and mixtures of the aforementioned polymers. In a particularly preferred embodiment of the invention, the thermoplastic polymer A1 comprises at least one polyolefin or consists of at least one polyolefin, where the polyolefin may be a polyolefin homopolymer and/or a polyolefin copolymer.

As well as the thermoplastic polymer A1, the thermoplastic molding compound A may optionally comprise at least one polar-functionalized polymer A2 comprising repeat units of at least one functional monomer A2-I. In addition, the thermoplastic molding compound A may comprise further polymers A3 that are different than polymers A1 and A2.

In one embodiment, the thermoplastic molding compound A1 contains up to 100% by weight of the at least one thermoplastic polymer A1 selected from homo- or copolymers of polyamide, polypropene and polyethene.

The thermoplastic molding compound A may additionally contain 0% to 99% by weight of the at least one polymer A2 and/or of polymers A3, based in each case on the total weight of the thermoplastic molding compound A.

In a preferred embodiment, the thermoplastic molding compound A contains 60% to 99.9% by weight, more preferably 70% to 99.9% by weight, particularly preferably 75% to 99.9% by weight, especially preferably 90% to 99% by weight, further preferably 94% to 97% by weight, of the at least one thermoplastic polymer A1, especially a thermoplastic polyolefin homopolymer or polyolefin copolymer A1, and 0.1% to 40% by weight, preferably 0.1% to 30% by weight, more preferably 0.1% to 20% by weight, especially preferably 1% to 10% by weight, further preferably 3% to 6% by weight, of the at least one polar-functionalized polymer A₂, where the figures in % by weight are each based on the total weight of the thermoplastic molding compound A.

In a preferred embodiment of the invention, the thermoplastic molding compound A comprises polymers A1 and A2 and does not comprise any further polymers A3.

In an alternative embodiment, the thermoplastic molding compound A comprises polymers A1 and A2 and optionally at least one further polymer A3. Typically, the at least one optional polymer A3 may be selected from any thermoplastic polymer other than A1 and A2. For example, the at least one optional polymer A3 may be selected from polystyrenes (PS), styrene/acrylonitrile copolymers (PSAN), acrylonitrile/butadiene/styrene copolymers (ABS), acrylate/styrene/acrylonitrile copolymers (ASA), polycarbonates, polyesters, polyamides, polyolefins and mixtures thereof. More preferably, the at least one optional polymer A3 is selected from polyethene, ethene/propene copolymers, styrene polymers and styrene/ acrylonitrile copolymers, with the proviso that the at least one polymer A3 is different than polymers A1 and A2. Preferably, polymer A3 may be at least one amorphous polymer.

In particular, the thermoplastic molding compound A includes a proportion by weight of less than 50% by weight of polymers A3, more preferably of less than 30% by weight.

The thermoplastic molding compound A preferably comprises (or consists of):
a-1) 50% to 99.9% by weight, preferably 70% to 99.9% by weight, more preferably 79% to 98% by weight, especially preferably 90% to 97% by weight, of a thermoplastic polymer A1;
a-2) 0.1% to 20% by weight, preferably 0.1% to 10% by weight, more preferably 1% to 8% by weight, especially preferably 3% to 7% by weight, of the at least one polar-functionalized polymer A2;
a-3) 0% to 49.9% by weight, preferably 0% to 29.9% by weight, more preferably 1% to 20% by weight, of at least one further polymer A3;
   where polymers A1, A2 and A3 are different than one another, and where the figures in % by weight are each based on the total weight of the thermoplastic molding compound A, and the sum total of components A1, A2 and A3 is 100% by weight. The thermoplastic molding compound A preferably comprises or consists of components A1, A2 and A3.

More preferably, the thermoplastic molding compound A comprises (or consists of):
a-1) 60% to 99% by weight of at least one polymer A1 selected from the group consisting of propene homopolymers, propene copolymers, styrene copolymers, polyamides and polycarbonates;
a-2) 1% to 40% by weight of a polar-functionalized polymer A2; and
a-3) 0% to 10% by weight of at least one further polymer A3, where polymer A3 is different than polymers A1 and A2.
   where polymers A1, A2 and A3 are different than one another, and
   where the figures in % by weight are each based on the total weight of the thermoplastic molding compound A, and the sum total of components A1, A2 and A3 is 100% by weight. The thermoplastic molding compound preferably consists of components A1, A2 and A3.

### Thermoplastic Polymer A1

The thermoplastic molding compound A preferably contains at least 50% by weight, more preferably at least 60% by weight, especially at least 80% by weight, of at least one thermoplastic polymer A1, preferably at least one polyolefin, based on the total weight of the thermoplastic molding compound A. The thermoplastic molding compound A preferably contains the at least one polymer A1 within a range from 70% to 99.9% by weight, more preferably 90% to 99% by weight, more preferably 92% to 97% by weight, based on the total weight of the thermoplastic molding compound A.

A thermoplastic polymer A1 is preferably an amorphous or semicrystalline homo- or copolymer of ethene, propene, butene and/or isobutene. Especially preferably, the polymer A1 comprises at least one propene homopolymer and/or propene-ethene copolymer (also referred to as polypropene impact copolymer). More preferably, polymer A1 comprises (or is) a propene-ethene copolymer.

Polymer A1 is preferably at least one propene-ethene copolymer, where the propene-ethene copolymer preferably has a melting mass flow rate MFR (determined to DIN EN

ISO 1133 at 230° C./2.16 kg) within a range from 40 g/10 min to 120 g/10 min, preferably 80 g/10 min to 120 g/10 min, especially 90 g/10 min to 110 g/10 min, and often about 100 g/10 min. Polymer A1 is preferably at least one propene-ethene copolymer having a density (to DIN EN ISO 1183-1:2019-09) of <0.95 g/cm³, especially within a range from 0.89 g/cm³ to 0.93 g/cm³, preferably 0.895 g/cm³ to 0.915 g/cm3.

The thermoplastic polymer A1 is at least one propene-ethene copolymer having a modulus of elasticity (measured to DIN EN ISO 178) within a range from 1400 MPa to 2100 MPa, often about 1550 MPa.

The thermoplastic polymer A1 preferably has a coefficient of thermal expansion α_{A1} to ISO 11359-1 and ISO 11359-2 within a range from 50*10⁻⁶ K⁻¹ to 100*10⁻⁶ K⁻¹, especially within a range from 60*10⁻⁶ K⁻¹ to 90*10⁻⁶ K⁻¹.

The thermoplastic polymer A1 preferably has a coefficient of thermal volume expansion α_{V,A1}, determined by the above-described formula, within a range from 150*10⁻⁶ K⁻¹ to 300*10⁻⁶ K⁻¹, especially within a range from 180*10⁻⁶ K⁻¹ to 270*10⁻⁶ K⁻¹.

The thermoplastic polymer A1 preferably has a melting point (DSC, measured to DIN EN ISO 11357-3) within a range from 100 to 200° C., especially within a range from 135 to 160° C.

Suitable polyolefins are available, for example, under the Rigidex 380-H100 trade name from INEOS Olefins & Polymers Europe.

### Polar-Functionalized Polymer A2

The optional polar-functionalized polymer A2 is different than polymer A1 and comprises repeat units of at least one functional monomer A2-I.

The thermoplastic molding compound A preferably contains at least 0.1% by weight, more preferably at least 1% by weight, especially preferably at least 3% by weight, and in particular at least 3% by weight, of the at least one polar-functionalized polymer A₂, based on the total weight of the thermoplastic molding compound A.

The thermoplastic molding compound A preferably contains at most 30% by weight, more preferably at most 20% by weight, especially at most 15% by weight, and in particular at most 10% by weight, of the at least one polar-functionalized compound A₂, based on the total weight of the thermoplastic molding compound A.

The thermoplastic molding compound A preferably contains the at least one polar-functionalized polymer A2 within a range from 0.1% to 30% by weight, preferably 0.1% to 20% by weight, more preferably 1% to 15% by weight, especially preferably 3% to 10% by weight, based on the total weight of the thermoplastic molding compound A.

The polar-functionalized polymer A2 serves as compatibilizer between the thermoplastic molding compound A and the continuous reinforcing fiber B. The polar-functionalized polymer A2 has at least one polar, preferably chemically reactive, functionality (typically provided by the repeat units of the at least one functional monomer A2-I) which, during the process for production of the composite material V, can react with chemical groups on the surface of the continuous reinforcing fibers B and can form bonds (covalent bonds, ionic bonds, van der Waals bonds), which affords a composite material V having good strength, especially good fiber-matrix adhesion.

The polar-functionalized polymer A2 often increases the polarity of the thermoplastic molding compound A, which increases compatibility with polar surfaces of the reinforcing fibers, especially the polar surfaces of glass fibers or surfaces of reinforcing fibers that have been polar-functionalized by sizing agents.

In a preferred embodiment, the polar-functionalized polymer A2 comprises at least 0.1% by weight, preferably 0.1% to 5% by weight, particularly preferably 0.1% to 3% by weight, especially preferably 0.1% to 1.5% by weight, more preferably 0.1% to 0.5% by weight, based on the total weight of polymer A₂, of repeat units of the at least one functional monomer A2-I.

In a preferred embodiment, the at least one functional monomer A2-I is selected from the group consisting of maleic anhydride (MA), N-phenylmaleimide (PM), tert-butyl (meth)acrylate and glycidyl (meth)acrylate (GM), especially selected from the group consisting of maleic anhydride (MA), N-phenylmaleimide (PM) and glycidyl (meth)acrylate (GM).

The polar-functionalized polymer A2 preferably comprises, as well as the repeat units A2-I, at least repeat units of a further monomer A2-II other than monomer A2-I. The proportion of repeat units of monomer A2-II by weight is up to 99.9% by weight, preferably within a range from 95% to 99.9% by weight, particularly preferably 97% to 99.9% by weight, especially preferably 98.5% to 99.9% by weight, more preferably 99.5% to 99.9% by weight, based on the total weight of polymer A₂, of repeat units of the at least one monomer A2-II.

Monomer A2-II is preferably selected from ethene, propene, butene and/or isobutene.

The polar-functionalized polymer A2 is preferably a copolymer of repeat units of at least one monomer A2-II selected from ethene, propene, butene and/or isobutene, and repeat units of at least one functional monomer A2-I selected from maleic anhydride, N-phenylmaleimide, tert-butyl (meth)acrylate and glycidyl (meth)acrylate. More preferably, the polar-functionalized polymer A2 is a copolymer of propene repeat units and repeat units of at least one functional monomer A2-I selected from maleic anhydride, N-phenylmaleimide, tert-butyl (meth)acrylate and glycidyl (meth)acrylate.

Particularly preferably, the polar-functionalized polymer A2 is a propene graft copolymer where repeat units of the abovementioned functional monomers A2-I are grafted onto a polypropene. The polar-functionalized polymer A2 is preferably a propene-maleic anhydride graft copolymer where the graft core consists predominantly of repeat propene units and the graft shell predominantly of repeat maleic anhydride units. Such polar-functionalized polymers A2 and the production thereof are described, for example, in patent US 10/189933 B2. They are known and commercially available, for example, under the product names PRIEX® 20093 (BYK), Orevac® CA100 (Arkema) and Scona® TPPP 9021 (BYK).

More preferably, the polar-functionalized polymer A2 is one or more propene-maleic anhydride graft copolymers having a proportion of maleic anhydride as monomer A2-1 within a range from 0.01% to 5% by weight, preferably 0.1% to 0.4% by weight, more preferably from 0.15% to 0.25% by weight, based on the total weight of the polar-functionalized polymer A2.

In particular, the polar-functionalized polymer A2 is a polymer having a density (to DIN EN ISO 1183-1:2019-09) within a range from 0.8 to 1.0 g/cm³, preferably within a range from 0.85 g/cm³ to 0.95 g/cm³, especially from 0.895 g/cm³ to 0.915 g/cm³, frequently of about 0.9 g/cm³.

Preferably, the polar-functionalized polymer A2 has a melt mass flow rate (MFR) (determined to DIN EN ISO 1133, at 190° C./0.325 kg) within a range from 8 g/10 min to 15 g/10 min, especially 9 g/10 min to 13 g/10 min.

Preferably, the polar-functionalized polymer A2 is a polymer having a melting point (measured to DIN EN ISO 11357-3) within a range from 160 to 165° C. and/or a viscosity (measured to DIN EN ISO 1628-1) within a range from 0.07 to 0.08 l/g.

In a particularly preferred embodiment, polymer A1 is a propene-ethylene copolymer, preferably having a density of 0.898 g/cm³ to 0.900 g/cm³; and the functionalized polymer A2 is a propene graft copolymer, for example PRIEX® 20093 from BYK-Chemie.

### Continuous Reinforcing Fiber B

The composite material V contains at least 20% by weight, preferably at least 40% by weight, more preferably at least 45% by weight, especially preferably at least 50% by weight, based on the total weight of the composite material V, of the continuous reinforcing fiber B. In a preferred embodiment, the composite material V contains >50% by weight, based on the total weight of the composite material V, of the continuous reinforcing fiber B.

The composite material V contains generally not more than 80% by weight, based on the total weight of the composite material V, of the continuous reinforcing fiber B.

The at least one continuous reinforcing fiber B is present in the composite material V at from 20% to 80% by weight, preferably from 40% to 80% by weight, more preferably from 50% to 80% by weight, based on the composite material V. In a preferred embodiment, the at least one continuous reinforcing fiber B is present in the composite material V at 51% to 80% by weight, based on the composite material V.

The continuous reinforcing fiber B is preferably present in the composite material V at from 20% to 80% by volume, preferably from 30% to 70% by volume and especially preferably from 40% to 55% by volume, based on the composite material V.

The continuous reinforcing fibers B are preferably selected from glass fibers, carbon fibers, aramid fibers and natural fibers and/or mixed forms of the continuous reinforcing fibers B mentioned. More preferably, the continuous reinforcing fibers B are selected from glass fibers and/or carbon fibers, especially glass fibers.

Typically, the density of the continuous reinforcing fibers B is within a range from 1.4 g/cm³ to 2.8 g/cm³. Preferably, the density of the continuous reinforcing fibers B, selected from glass fibers, is within a range from 1.8 g/cm³ to 2.8 g/cm³. Preferably, the density of the continuous reinforcing fibers B, selected from carbon fibers, is within a range from 1.4 g/cm³ to 1.9 g/cm³. Suitable methods of determining density are known to the person skilled in the art. The density of the continuous reinforcing fibers B is typically determined in accordance with test standard ASTM C693.

The continuous reinforcing fiber B is typically a bundle of a multitude of filaments. Such filament bundles (also referred to as multifilaments) are formed in the production of fibers. The continuous reinforcing fiber B of the invention therefore corresponds to a filament bundle composed of a multitude of individual filaments.

Typically, the continuous reinforcing fiber B comprises a multitude of individual filaments, where the average filament diameter is within a range from 2 to 35 μm, preferably 5 to 25 μm.

The filaments of the continuous reinforcing fiber B are often bundled to rovings, weaves and/or yarns.

In a further preferred embodiment, the continuous reinforcing fibers B, on at least part of their surface, have one or more functional groups, preferably polar functional groups, especially preferably functional groups selected from hydroxy, ester, amino and silanol groups. The polar functional groups on the surface of the continuous reinforcing fibers B may be formed directly by the fiber material itself (especially in the case of glass fibers) or may have been applied to the surface of the continuous reinforcing fibers B by the applying of at least one sizing agent.

In one embodiment of the invention, the continuous reinforcing fiber B may thus comprise a sizing agent applied to at least part of the surface of the continuous reinforcing fiber B. Fibers for fibrous reinforcing materials are frequently treated with a sizing agent, especially in order to protect the reinforcing fibers. It is thus possible to prevent mutual damage by abrasion. If any mechanical interaction occurs, this must not cause any cross-fragmentation (fracture) of the reinforcing fibers. In addition, the sizing agent can prevent agglomeration of the reinforcing fibers. A sizing agent may also contribute to improved cohesion between the reinforcing fibers and the polymer matrix in the composite material V.

Suitable sizing agents generally include a large number of different constituents such as film formers, lubricants, wetting agents and adhesives.

Film formers protect the fibers from mutual friction and can also increase affinity for polymers, in order hence to promote strength and adhesion of the composite material. These include starch derivatives, polymers and copolymers of vinyl acetate and acrylic esters, epoxy resin emulsions, polyurethane resins and polyamides with a proportion of 0.5% to 12% by weight, based on the total weight of the sizing agent.

Lubricants impart suppleness to the fibers and products thereof, and reduce mutual friction between the reinforcing fibers. It is often the case, however, that adhesion between reinforcing fiber and polymer is impaired by the use of lubricants. These include fats, oils and polyalkyleneamines in an amount of 0.01% to 1% by weight, based on the total weight of the sizing agent.

Wetting agents result in a reduction in surface tension and improved wetting of the filaments with the sizing agent. For aqueous modification, examples include poly(fatty acid amides) in an amount of 0.1% to 5% by weight, based on the total weight of the sizing agent.

There is often no suitable affinity between the polymer matrix and the reinforcing fibers. This can be overcome by adhesives that increase the adhesion of polymers on the fiber surface. Typically, organofunctionalized silanes such as aminopropyltriethoxysilane, methacryloyloxypropyltrimethoxysilane, glycidyloxypropyltrimethoxysilane and the like are used.

In an alternative preferred embodiment of the invention, the continuous reinforcing fibers B of the present invention are (essentially) free of a sizing agent, i.e. comprise less than 3% by weight, preferably less than 1% by weight and especially less than 0.1% by weight of sizing agent, based on the total weight of the continuous reinforcing fibers B. If the continuous reinforcing fibers B (for example as a result of production) comprise a sizing agent that has been applied to at least part of the surface of the continuous reinforcing fibers B, the sizing agent may be removed before use according to the present invention.

This can be achieved, for example, by thermal desizing processes (for example combustion of the sizing agent).

In one embodiment, the continuous reinforcing fiber B is one or more glass fibers. Especially preferably, the at least one continuous reinforcing fiber B is one or more glass fibers comprising surface functional groups selected from hydroxy, ester, amino and silanol groups, preferably silanol groups.

Typically, the known qualities of glass fibers are used, depending on the requirements and field of use, for example glass fibers of the following types: E glass (E=electric; aluminum borosilicate glass with less than 2% alkali metal oxides), S glass (S=strength; aluminum silicate glass with additions of magnesium oxide), R glass (R=resistance, aluminum silicate glass with additions of calcium oxide and magnesium oxide), M glass (M=modulus, beryllium-containing glass), C glass (C=chemical, fiber with elevated chemical stability), ECR glass (corrosion-resistant E glass), D glass (D=dielectric, fiber with low dielectric loss factor), AR glass (AR=alkaline resistant, fiber developed for use in concrete, enriched with zirconium(IV) oxide), Q glass (Q=quartz, fiber of quartz glass SiO₂) and hollow glass fibers.

It is often the case that glass fibers of the E glass type are used as standard fiber for general plastic reinforcement and for electrical applications. In a preferred embodiment of the invention, glass fibers having a filament diameter of 5 to 25 μm are used, which are typically referred to collectively as multifilament yarn (roving). Such a multifilament yarn (roving) preferably has a fineness of 1200 tex. These are preferably used both as warp and weft threads in a fabric G.

In addition, it is also possible to use carbon fibers as continuous reinforcing fiber B. Typically, carbon fibers are industrially manufactured fibers made from carbon-containing starting materials that are typically converted to carbon in a graphite-like arrangement by chemical reactions matched to the raw material. It is possible to use standard isotropic and anisotropic types, where anisotropic fibers typically have high strengths and stiffnesses with simultaneously low elongation at break in axial direction. It is often the case that carbon fibers are used as stiffening component for lightweight construction. Typically, carbon fibers have a diameter of about 5 to 9 micrometers, with combination of typically 1000 to 24 000 filaments to give a multifilament yarn (roving).

The continuous reinforcing fiber B is preferably used in the form of fabric G. The fabric G is preferably a laid scrim, a weave, a mat, a nonwoven, a knit, a braid or a multiaxial scrim formed at least partly from filament bundles of the continuous reinforcing fibers B. The continuous reinforcing fiber B is preferably embedded in the composite material V as a fabric G, preferably selected from weaves, mats, nonwovens, laid scrims and knits, especially weaves and scrims.

The further processing of continuous reinforcing fibers B to give fabrics G in the form of semifinished textile products, for example laid scrims, weaves, mats, nonwovens, nets, braids or multiaxial scrims, is typically effected on weaving machines, braiding machines or multiaxial knitting machines, or, in the field of production of fiber-reinforced plastics, directly in prepreg plants, pultrusion plants or winding machines.

The continuous reinforcing fibers B may be embedded into the composite material V as a fabric G in any orientation and arrangement. It is often the case that the continuous reinforcing fibers B are not in statistically uniform distribution in the composite material V, but in the form of a fabric G, i.e. in planes with a higher and with a lower proportion (and therefore as more or less separate plies). The starting point is preferably a laminate-type or laminar construction of the composite material V, where the composite material V comprises a multitude of fabrics G comprising the continuous reinforcing fibers B.

Two-dimensional laminates formed in this way typically contain a layered construction of composites composed of two-dimensional reinforcing plies (fabric G comprising continuous reinforcing fibers B) and plies of a wetting and coherent matrix composition (also referred to hereinafter as matrix composition M) comprising at least the thermoplastic molding compound A. In a preferred embodiment, the continuous reinforcing fibers B are embedded layer by layer into the composite material V. The continuous reinforcing fibers B are preferably in the form of a fabric G.

In a laid scrim, the fibers are typically in parallel and extended form. Usually, continuous fibers are used. Fabrics are typically the result of the weaving of continuous fibers, for example of rovings. The weaving of fibers is inevitably associated with deflection (undulation) of the fibers. The undulation especially results in lowering of compressive strength parallel to the fiber. Mats usually consist of long fibers that have been loosely bonded to one another by means of a binder. The use of long fibers means that the mechanical properties of components made from mats are inferior to those of weaves.

Nonwovens are typically fabrics composed of fibers of limited length, continuous fibers (filaments) and/or chopped yarns that have been combined in any known manner to give a nonwoven and have usually been bonded by means of a binder. Typically referred to filament systems that have formed and been bonded via loop formation.

In a further embodiment, the invention relates to a composite material V which has a fin structure or a sandwich structure and has a layered construction. The process steps for formation of a fin structure are known to those skilled in the art.

In a further embodiment, the invention relates to a composite material V as described herein, wherein the composite material V has a layer construction and contains more than two, often more than three, layers. By way of example, all layers may be the same, or some of the layers may have a different construction. A layer comprises at least one fabric G composed of continuous reinforcing fibers B embedded into at least one matrix composition (also referred to herein as matrix composition M) comprising the thermoplastic molding compound A.

### Particulate Inorganic Filler C

The composite material V contains at least 1% by weight, preferably at least 3% by weight, more preferably at least 4% by weight, based on the total weight of the composite material V, of at least one particulate inorganic filler C. The composite material V contains at most 60% by weight, preferably at most 45% by weight, more preferably at most 40% by weight, based on the total weight of the composite material V, of at least one particulate inorganic filler C.

The at least one particulate inorganic filler C is present in the composite material V at from 1% to 60% by weight, preferably 3% to 45% by weight, especially preferably 5% to 40% by weight, based on the overall composite material V.

In a preferred embodiment, the inventive composite material V contains at least 5% to 60% by volume, preferably 15% to 50% by volume and especially preferably 25% to 40% by volume, based on the composite material V, of at least one particulate inorganic filler C.

The particulate inorganic filler C is preferably selected from glass fillers, mineral fillers, ceramic fillers and mixtures thereof.

Suitable glass fillers especially include glass powder and hollow glass bodies, more preferably hollow glass bodies. Hollow glass bodies are notable for a particularly low density and hence enable the production of fiber-reinforced composite materials V having a low density. These are advantageous as lightweight but mechanically stable materials.

Suitable mineral fillers especially include silicates, phosphates, sulfates, carbonates, hydroxides and borates, more preferably carbonates. Carbonates, especially calcium carbonate, advantageously feature global availability at low cost and are additionally commercially available in many different size distributions.

Suitable ceramic fillers especially include boron nitrite (BN—Borazon), aluminum oxide (Al₂O₃), silicates, silicon dioxide, zirconium(IV) oxide, titanium(IV) oxide, aluminum titanate, barium titanate, and silicon carbide (SiC) and boron carbide (B₄C). Ceramic fillers especially contribute to improvement of hardness and scratch resistance of the composite material V.

The at least one particulate inorganic filler C is preferably selected from mineral fillers that may be either in crystalline form or in amorphous form (especially as glass fillers). The at least one particulate inorganic filler C is preferably selected from glass powder, hollow glass bodies, amorphous silica; carbonates (e.g. magnesium carbonate, calcium carbonate (chalk)); powdered quartz; mica; silicates, for example clays, muscovite, biotite, suzoite, tin maletite, talc, chlorite, phlogopite, feldspar; kaolin and calcium silicates (for example wollastonite). Very particular preference is given to hollow glass bodies, and carbonates, especially calcium carbonate (chalk).

In a preferred embodiment, the composite material V of the invention contains 3% to 45% by weight of at least one particulate inorganic filler C in crystalline and/or amorphous form, selected from silicates, phosphates, sulfates, carbonates and borates.

In a further-preferred embodiment, the composite material V of the invention comprises ≥20% to ≤45% by weight, more preferably ≥30% to ≤40% by weight, of at least one particulate inorganic filler C selected from inorganic carbonates, preferably calcium carbonate. It has been shown that, in spite of this large amount of filler C, it is possible to provide a composite material V that has good mechanical properties and at the same time has surfaces having particularly low surface corrugation, i.e. having a particularly smooth surface.

In a further alternative preferred embodiment, the composite material V of the invention comprises ≥1% to ≤20% by weight, preferably ≥3% to ≤10% by weight, of at least one particulate inorganic filler C selected from hollow glass bodies. It has been shown that this amount of hollow glass bodies is suitable for providing a composite material V having surfaces having particularly low surface corrugation, i.e. having a particularly smooth surface.

In a preferred embodiment, fillers C having an average particle size D50 within a range of up to 300 μm, more preferably of up to 100 μm, particularly preferably of up to 70 μm, especially within a range from 1 μm to 50 μm, are used as particulate inorganic filler C.

According to the invention, inorganic fillers C are used that have a coefficient of linear thermal expansion ac (CLTE, measured according to ISO 11359-1 and ISO 11359-2) which is lower than the coefficient of linear thermal expansion α_{A} of the thermoplastic molding compound A, i.e. α_{C}<α_{A}. The following relationship is preferably applicable: α_{C}<0.3 α_{A}.

The at least one particulate inorganic filler C preferably also has a coefficient of linear thermal expansion α_{C} (CLTE, measured to ISO 11359-1 and ISO 11359-2) which is 0.2 to 5 times, more preferably 0.3 to 1 times, the coefficient of linear thermal expansion α_{B} of the continuous reinforcing fiber B, i.e. the following relationship is applicable: 0.2·α_{B}≥α_{C}≤5·α_{B}, especially 0.3·α_{B}≤α_{C}≤1·α_{B}.

The particulate inorganic filler C preferably has a coefficient of linear thermal expansion ac (CLTE, measured to ISO 11359-1 and ISO 11359-2) within a range from 2*10⁻⁶ K⁻¹ to 20*10⁻⁶ K⁻¹, preferably 5*10⁻⁶ K⁻¹ to 15*10⁻⁶ K⁻¹, especially preferably 7*10⁻⁶ K⁻¹ to 12*10⁻⁶ K⁻¹.

According to the invention, inorganic fillers C are used for which the following relationship (II) is applicable:

$$\frac{{∝}_{V , C} \times proportion of C \times density of B in g / ml}{{∝}_{V , B} \times proportion of B \times density of C in g / ml} = 0.1 to 2 \qquad ( II )$$

with:
α_{V,C}=coefficient of thermal volume expansion of component C in 1/K,

proportion of C=proportion by weight of component C in the overall composite material V in % by weight/100,
α_{V,B}=coefficient of thermal volume expansion of component B in 1/K, proportion of B=proportion by weight of component B in the overall composite material V in % by weight/100;
   and where:

α_{V,C}=3*α_{C}; and

α_{V,B}=3*α_{B}

with:
α_{A}=average coefficient of linear thermal expansion of component A;
α_{B}=average coefficient of linear thermal expansion of component B; and
α_{C}=average coefficient of linear thermal expansion of component C.

Details of the determination of the coefficient of linear thermal expansion a and of the coefficient of thermal volume expansion av have been given further up.

The following relationship (IV) is preferably applicable:

$$\frac{{∝}_{V , C} \times proportion of C \times density of B in g / ml}{{∝}_{V , B} \times proportion of B \times density of C in g / ml} = 0.44 to 1.5 \qquad ( IV )$$

It has been observed that, in the case of a value of ≥0.44 in relationship (IV), a reduction in surface corrugation of the resultant composite material V by 50% was achievable.

More preferably, the following relationship (V) is applicable:

$$\frac{{∝}_{V , C} \times proportion of C \times density of B in g / ml}{{∝}_{V , B} \times proportion of B \times density of C in g / ml} = 0.5 to 1.2 \qquad ( V )$$

The density of the inorganic fillers C is preferably within a range from 0.1 to 5 g/ml, more preferably especially 0.2 to 4 g/ml, especially 0.2 to 2.8 g/ml. Suitable methods of determining density are known to the person skilled in the art. The density of inorganic fillers C is typically determined according to test standard DIN-ISO 787/10. The density of hollow glass beads that can be used with preference in accordance with the invention as particulate inorganic filler C is preferably within a range from 0.1 to 1.0 g/ml, more preferably within a range from 0.2 to 0.6 g/ml. The density of carbonates that can be used with preference in accordance with the invention as particulate inorganic filler C is preferably within a range from 1.0 to 4.0 g/ml, more preferably within a range from 2.0 to 2.8 g/ml.

In one version of the production of the composite material V of the invention, the particulate inorganic filler C is typically added to the thermoplastic molding compound A before the components are contacted with the continuous reinforcing fiber B. In another version, all three components are combined in one process step. Further details for production of the composite material V of the invention can be found in the section on the production method which is included herein.

### Further Additives D

The composite material V of the invention may optionally contain 0% to 10% by weight, preferably 0% to 5% by weight, more preferably 0.01% to 10% by weight, more preferably 0.1% to 5% by weight, based on the overall composite material V, of one or more additives D. Typically, the optional additive D comprises customary auxiliaries and additives other than components A to C. Typical plastics additives are described, for example, in H. Zweifel et al., Plastics Additives Handbook, Hanser Verlag, 6th edition, 2009.

In the production of the composite material V of the invention, the additives D are typically added to the thermoplastic molding compound A.

For example, the at least one further additive D may be selected from processing auxiliaries, stabilizers, lubricants and demolding agents, flame retardants, dyes, pigments and plasticizers. Stabilizers used are, for example, antioxidants (oxidation retardants) and agents to counter thermal decomposition (thermal stabilizers) and breakdown by ultraviolet light (UV stabilizers).

Suitable UV stabilizers are, for example, various substituted resorcinols, salicylates, benzotriazoles and benzophenones. UV stabilizers are typically used in amounts of up to 2% by weight, preferably of 0.01% to 2% by weight, based on the overall composite material V. Standard UV stabilizers are described, for example, in H. Zweifel et al., Plastics Additives Handbook, Hanser Verlag, 6th edition, 2009, p. 246-329.

Suitable antioxidants and thermal stabilizers are, for example, sterically hindered phenols, hydroquinones, substituted representatives of that group, secondary aromatic amines, optionally in conjunction with phosphorus acids or salts thereof, and mixtures of these compounds. Standard antioxidants are described, for example, in H. Zweifel et al., Plastics Additives Handbook, Hanser Verlag, 6th edition, 2009, p. 40 to 64. Preference is given to using antioxidants of the Irganox® type (BASF). Antioxidants and thermal stabilizers are typically used in amounts of up to 1% by weight, preferably of 0.01% to 1% by weight, based on the overall composite material V.

In a preferred embodiment, the composite material V of the invention contains one or more lubricants and demolding agents as additives D. Standard lubricants and demolding agents are described, for example, in H. Zweifel et al., Plastics Additives Handbook, Hanser Verlag, 6th edition, 2009, p. 563-580. Suitable lubricants and demolding agents are, for example, stearic acid, stearyl alcohol, stearic esters and stearamides, and esters of pentaerythritol with long-chain fatty acids. It is possible to use, for example, the calcium, zinc, or aluminum salts of stearic acid, and also dialkyl ketones, for example distearyl ketone.

It is additionally also possible to use ethene oxide-propene oxide copolymers as lubricants and demolding agents. It is also possible to use natural and/or synthetic waxes. Examples of these include PP waxes, PE waxes, PA waxes, grafted PO waxes, HDPE waxes, PTFE waxes, EBS waxes, montan wax, carnauba wax and beeswax. Lubricants and demolding agents are typically used in amounts of up to 1% by weight, preferably of 0.01% to 1% by weight, based on the overall composite material V.

In a preferred embodiment of the invention, the composite material V of the invention contains 0.01% to 1% by weight, preferably 0.1% to 0.9% by weight, of lubricant and demolding agent as additives D, with lubricant and demolding agent is preferably selected from stearic esters, especially preferably from glycerol monostearate, more preferably 1-glycerol monostearate.

Suitable flame retardants may be not only halogen-containing but also halogen-free compounds. Suitable halogen compounds are chlorinated and/or brominated compounds, brominated compounds being preferable over chlorinated compounds. It is preferable to use halogen-free compounds, for example phosphorus compounds, in particular phosphine oxides and derivatives of phosphorus acids, and salts of phosphorus acids and of phosphorus acid derivatives. It is particularly preferable that phosphorus compounds comprise ester groups, alkyl groups, cycloalkyl groups, and/or aryl groups. Oligomeric phosphorus compounds with molar mass smaller than 2000 g/mol as described by way of example in EP-A 0 363 608 are likewise suitable.

In addition, pigments and dyes may be present as additives D in the composite materials V of the invention. These are typically present in amounts of 0% to 10% by weight, preferably 0.1% to 10% by weight and especially 0.5% to 8% by weight, based on the overall composite material V. Typical pigments for coloring of thermoplastics are common knowledge; see, for example, H. Zweifel et al., Plastics Additives Handbook, Hanser Verlag, 6th edition, 2009, p. 855-868 and 883-889, and also R. Gächter and H. Müller, Taschenbuch der Kunststoffadditive [Handbook of Plastics Additives], Carl Hanser Verlag, 1983, p. 494 to 510. A first preferred group of pigments that may be mentioned is that of white pigments such as zinc oxide, zinc sulfide, white lead (2 PbCO₃·Pb(OH)₂), lithopones, antimony white, and titanium dioxide. Of the two most familiar crystalline forms of titanium dioxide (rutile and anatase) it is in particular the rutile form that is used for the white coloring of the molding compounds of the invention. A further preferred group of pigments is that of black pigments, for example iron oxide black (Fe₃O₄), spinel black (Cu(Cr,Fe)₃O₄), manganese black (a mixture of manganese dioxide, silicon oxide, and iron oxide), cobalt black, and antimony black, and also more preferably carbon black, which is mostly used in the form of furnace black or gas black (in this connection see G. Benzing, Pigmente für Anstrichmittel [Pigments for Paints], Expert-Verlag (1988), pp. 78ff).

It is also possible to use inorganic chromatic pigments such as chrome oxide green or organic chromatic pigments such as azo pigments and phthalocyanines in the invention in order to establish particular hues. Pigments of this type are generally obtainable commercially. It can further be of advantage to use the abovementioned pigments or dyes in a mixture, for example carbon black with copper phthalocyanines.

As well as the additives mentioned, which are typically added to the thermoplastic molding compound A, the continuous reinforcing fibers B may also comprise additives, especially in the form of a surface coating of what is called a size (sizing agent). Typically, sizing agents contain a large number of different constituents such as film formers, lubricants, wetting agents and adhesives. These are described in detail in the section of the description of continuous reinforcing fibers B.

Process for producing the fiber-reinforced composite material V

The invention further provides a process for producing the composite materials V of the invention, wherein the process comprises at least the following process steps:
i) providing at least one continuous reinforcing fiber B, at least one thermoplastic molding compound A, at least one particulate inorganic filler C, and optionally at least one additive D;
ii) combining the at least one thermoplastic molding compound A, the at least one particulate inorganic filler C, and optionally the at least one additive D, with the at least one continuous reinforcing fiber B;
iii) impregnating the continuous reinforcing fiber B with the at least one thermoplastic molding compound A, the at least one particulate inorganic filler C, and optionally the at least one additive D, in order to obtain a composite material V;
iv) consolidating the resultant composite material V;
v) optionally solidifying the resultant composite material V and/or optionally further process steps.

The preferred embodiments with regard to the composition of the composite material V and of components A, B, C and D, as described above in connection with the composite material V, are correspondingly also applicable to the process of the invention.

The continuous reinforcing fiber B is provided in process step (i) preferably in the form of a two-dimensional structure, especially a fabric G. This is provided preferably in two-dimensional form over its full spatial extent. Preference is given to using the fabric F described herein, such as weave, mat, nonwoven, laid scrim or knit, comprising the continuous reinforcing fibers B. More preferably, weaves or laid scrims, especially weaves, comprising or consisting of the continuous reinforcing fibers B are used. The fabric G has a first surface and a second surface.

Components A and optionally D may be provided in powder form, in granule form, in molten form or in film form, alone or in conjunction with the filler C. For this purpose, it is generally advantageous first to produce a thermoplastic matrix composition M comprising at least components A and optionally D.

According to the invention, the thermoplastic matrix composition M comprises at least the thermoplastic molding compound A described herein, comprising at least one thermoplastic matrix polymer A1, and optionally at least one polar-functionalized polymer A2 comprising at least one repeat unit of a functional monomer A2-I, and optionally further polymers A3 and/or optional additives D. It is additionally possible to introduce the at least one particulate inorganic filler C described herein, especially hollow glass bodies and/or carbonates, into the thermoplastic matrix composition M.

In a preferred embodiment, the thermoplastic matrix composition M comprises the at least one thermoplastic molding compound A and optionally the additives D, or consists of these components A and D. In one embodiment, the particulate inorganic filler C is introduced into the thermoplastic matrix composition M in order to obtain a mixture of matrix composition M and filler C. In one execution, the thermoplastic matrix composition M is provided by mixing the molding compound A and optionally the additives D, where the filler C can additionally be introduced into the matrix composition in the same process step.

In one embodiment, the thermoplastic matrix composition M comprises the thermoplastic molding compound A and optionally the additives D, and is (essentially) free of the particulate inorganic filler C. In this embodiment, the inorganic filler is introduced into the composite material V during the production thereof independently of the thermoplastic matrix composition M. The different production methods are described in detail hereinafter.

The thermoplastic matrix composition M can be provided by known methods, especially by coextrusion, kneading and/or rolling of polymers A1 and optionally A2 and/or A3 with the optional additives D. If the filler C is to be used together with the thermoplastic matrix composition M in the production of the composite material V, the filler C may advantageously likewise be incorporated into the thermoplastic matrix composition M together with the polymers A1 and optionally A2 and/or A3 with the optional additives D by coextrusion, kneading and/or rolling.

The thermoplastic matrix composition M may be provided in the form of powder, granules, a melt or a film. The thermoplastic matrix composition M is preferably provided as a film, especially as a film having a thickness of 25 μm to 500 μm, preferably 50 to 400 μm, more preferably 65 to 200 μm. The film may comprise the filler C or be (essentially) free of filler C.

Components A and optionally D, or thermoplastic matrix composition M, may thus be combined with the fabric G composed of continuous reinforcing fibers B in process step (ii) as powder, as granules, as a melt or as a film, alone or in conjunction with the filler C.

In one embodiment of the invention, components A and optionally D are preferably combined with the continuous reinforcing fiber B as a film, i.e. as a film composed of matrix composition M, and component C as powder.

In an alternative embodiment of the invention, components A, C and optionally D are preferably combined with the continuous reinforcing fiber B as a film, i.e. as a film composed of matrix composition M and the filler C.

In a particularly preferred embodiment, components A and optionally D are combined with the continuous reinforcing fiber B as a film, where the film may optionally comprise the filler C. The film preferably has a thickness of 25 μm to 500 μm, preferably 50 to 400 μm, more preferably 65 to 200 μm.

In a preferred embodiment, the thermoplastic matrix composition M comprises 20% to 80% by volume, preferably 20% to 70% by volume, especially 30% to 60% by volume, based on the total volume of the matrix composition M, of the at least one particulate inorganic filler C, preferably selected from particulate mineral or amorphous (vitreous) spherical fillers, preferably selected from hollow glass beads or carbonates. The remainder of the thermoplastic matrix composition M consists of the thermoplastic molding compound A described here, which preferably consists of polymers A1 and A₂, and optionally additives D.

The combining of the at least one thermoplastic molding compound A, at least one particulate inorganic filler C, and optionally at least one further additive D, with the at least one continuous reinforcing fiber B is preferably effected at elevated temperature. More preferably, components A, B, C and optionally D are heated to a temperature of more than 130° C., especially of at least 160° C. Preferably, process step (ii) is conducted at least temporarily at a temperature within a range from 160° C. to 350° C., more preferably at a temperature within a range from 190° C. to 290° C. This achieves fixing of the construction obtained. In general, a time interval of 0.1 to 30 minutes, more preferably of 0.2 to 10 minutes, is sufficient to achieve sufficient fixing of the continuous reinforcing fibers B and the thermoplastic molding compound A. Suitable methods and devices are known to the person skilled in the art. For example, it is advantageously possible to use interval hot presses.

Process step (ii) will preferably be conducted in such a way that at least one layer construction L composed of at least two layers is obtained, where the layer construction L has at least one layer of reinforcing fibers B, especially a layer of a fabric G composed of reinforcing fibers B, at least one layer comprising the thermoplastic molding compound A, and at least one layer comprising at least the filler C. The at least one layer comprising at least the thermoplastic molding compound A and the at least one layer comprising at least the filler C may be the same or different. This means that there may be at least one layer comprising at least the thermoplastic molding compound A and there may be at least one separate layer comprising at least the filler C, or there may be at least one layer comprising at least the thermoplastic molding compound A and at least the filler C.

In a preferred embodiment of the invention, a layer construction L composed of at least one layer of reinforcing fibers B, especially a layer of a fabric G composed of reinforcing fibers B, and at least two layers comprising at least the thermoplastic molding compound A and the filler C are provided, where the at least two layers comprising at least the thermoplastic molding compound A and the filler C are respectively disposed on the first and second surfaces of the at least one layer of reinforcing fibers B, especially a layer of a fabric G composed of reinforcing fibers B, such that the at least one layer of reinforcing fibers B, especially a layer of a fabric G made of reinforcing fibers B, is disposed between at least one layer on each side that comprises the thermoplastic molding compound A and the filler C.

In a further embodiment of the invention, a layer construction L composed of a multitude (i.e. at least 4) layers is provided, where the layer construction L comprises at least n layers of reinforcing fibers B, especially a layer of a fabric G composed of reinforcing fibers B, and at least m layers comprising at least the thermoplastic molding compound A and the filler C, where n ≥1, especially ≥₂, and m ≥1, preferably ≥2. Mutually adjoining layers may be the same or different than one another. Optionally, the layer construction L may additionally comprise further layers containing the at least one thermoplastic molding compound A, but containing (essentially) no filler C. In order to achieve the effect of the invention of improved surface quality, it is necessary that at least the layers that are to form the surface of the layer construction L (and hence also of the later composite material V) and are to have a particularly high surface quality comprise at least the thermoplastic molding composition A and the filler C. Such a layer is also referred to herein as surface layer O.

Layers of reinforcing fibers B are especially provided in the form of layers of a fabric G composed of reinforcing fibers B.

Layers of thermoplastic molding compound A (i.e. without the filler C) are especially provided in the form of powders, granules, melts or films that comprise the molding compound A and optionally additives D. These are preferably applied directly on at least one surface of an adjacent layer, especially a layer of reinforcing fibers B, for example a layer of a fabric G. This can be effected by scattering (in the case of powders or granules), casting and/or coating (in the case of melts), or laying (in the case of films).

Preference is given to applying layers of thermoplastic molding compound A in the form of powders or films.

According to the invention, layers of thermoplastic molding compound A and filler C are provided in the form of powders, granules, melts or films that comprise the molding compound A, the filler C and optionally additives D. These are preferably applied directly on at least one surface of an adjacent layer, especially a layer of reinforcing fibers B, for example a layer of a fabric G. This can be effected by scattering (in the case of powders or granules), casting and/or coating (in the case of melts), or laying (in the case of films). The molding compound A and the filler C may be applied separately or together. For example, the filler C may be applied by scattering in the form of a powder on at least one surface of an adjacent layer, especially a layer of reinforcing fibers B, for example a layer of a fabric G, which is then covered with powders, granules, melts or films containing the molding compound A. Alternatively, the filler C in the form of a powder and the molding compound A in the form of a powder or granules may be applied essentially simultaneously to at least one surface of an adjacent layer, especially a layer of reinforcing fibers B, for example a layer of a fabric G. It is also possible in accordance with the invention first to provide a mixture of thermoplastic molding compound A and filler C in the form of a powder, granules, a melt or a film, which are then applied collectively to at least one surface of an adjacent layer, especially a layer of reinforcing fibers B, for example a layer of a fabric G.

In a preferred embodiment of the invention, the layer construction L comprises at least one surface layer O which is formed from a film comprising at least one thermoplastic molding compound A and optionally additives D.

In a further embodiment of the invention, the layer construction L comprises at least one surface layer O, which is obtained by first scattering at least one filler C in the form of a powder on at least one surface of an adjacent layer, especially a layer of reinforcing fibers B, for example a layer of a fabric G, and then covering it with at least one film comprising at least one thermoplastic molding compound A and optionally additives D.

Such a layer construction L is especially suitable for distinctly reducing the occurrence of adhering filler on the compression mold in production.

In a further preferred embodiment of the invention, the layer construction L comprises at least one surface layer O, which is obtained by placing a film comprising at least one thermoplastic molding compound A, at least one filler C and optionally additives D on at least one surface of an adjacent layer, especially a layer of reinforcing fibers B. Such a layer construction L is especially suitable for distinctly reducing the occurrence of adhering filler on the compression mold in production, and additionally facilitates the use of fillers C having particularly low density and/or particularly low average particle size, without these being distributed undesirably during the production process and hence, for example, contaminating the production plants.

The layer construction L thus obtained is preferably fixed in process step (ii) by heating. More preferably, the layer construction L is heated to a temperature of more than 130° C., especially of at least 160° C. Preferably, process step (ii) is conducted at least temporarily at a temperature within a range from 160° C. to 350° C., more preferably at a temperature within a range from 190° C. to 290° C. This achieves fixing of the layer construction L obtained. In general, a time interval of 0.1 to 30 minutes, more preferably of 0.2 to 10 minutes, is sufficient to achieve sufficient fixing of the layer construction L. Suitable methods and devices are known to the person skilled in the art. For example, it is advantageously possible to use interval hot presses. The layer construction L is then sent to process step (iii).

In process step (iii), the continuous reinforcing fiber B is impregnated with the at least one thermoplastic molding compound A, the at least one particulate inorganic filler C, and optionally the at least one further additive D, or with the matrix composition M. For this purpose, the preliminarily fixed construction obtained in process step (ii), especially the layer construction L, is heated to a temperature of at least 180° C., more preferably at a temperature within a range from 200 to 290° C., in order to melt the thermoplastic molding compound A and hence to enable the impregnation.

On account of the comparatively low viscosity of the thermoplastic molding compound A, preferably complete impregnation of the continuous reinforcing fibers B with the molding compound A is possible with sufficient speed.

In general, a time interval of 0.1 to 30 minutes, more preferably of 0.2 to 10 minutes, is sufficient to achieve complete impregnation of the continuous reinforcing fibers B with the thermoplastic molding compound A. The thermoplastic molding compound A penetrates into the interspaces between individual continuous reinforcing fibers B, and also partly into interspaces between the individual filaments (i.e. in the filament bundles) from which the continuous reinforcing fibers B are formed. The optional additives D generally penetrate into said interspaces in the filament bundles together with the thermoplastic molding compound A.

According to the invention, the inorganic fillers C penetrate into the filament bundle of the continuous reinforcing fibers B only to an extent of not more than 10%. This increases the local concentration of filler C outside the filament bundle. This has a positive effect on the surface quality of the composite materials V, which have a particularly low level of surface corrugation. The corrugation present as a result of the continuous reinforcing fibers B is thus compensated for by the filler C. This effect is achievable by virtue of the properties of the particulate inorganic filler C, of the continuous reinforcing fibers B and of the thermoplastic molding compound A that have been described herein, especially by the relationships thereof with regard to the coefficient of thermal expansion and volume shrinkage.

The process for producing the composite material V of the invention preferably comprises the steps of:
i-1) providing at least one continuous reinforcing fiber B, where the surface of the continuous reinforcing fibers B comprises one or more functional groups selected from hydroxy, ester, amino and silanol groups, preferably in the form of at least one fabric G;
i-2) providing at least one thermoplastic molding compound A, where the thermoplastic molding compound A comprises at least one thermoplastic polymer A1 and optionally at least one polar-functionalized polymer A2 comprising at least repeat units of at least one functional monomer A2-I;
i-3) providing at least one particulate inorganic filler C, and
i-4) optionally providing at least one further additive D;
ii) combining the at least one thermoplastic molding compound A, at least one particulate inorganic filler C, and optionally at least one further additive D, with the at least one continuous reinforcing fiber B, where the components are combined at a temperature of at least 160° C., preferably at a temperature within a range from 160° C. to 350° C., more preferably at a temperature within a range from 190° C. to 290° C., in order to obtain a preliminary fixed construction, especially a layer construction L;
iii) impregnating the continuous reinforcing fiber B with the at least one thermoplastic molding compound A, the at least one particulate inorganic filler C, and optionally the at least one further additive D, in order to obtain a composite material V, where the impregnation is effected at a temperature of at least 180° C., more preferably at a temperature within a range from 200 to 290° C.;
iv) consolidating the resultant composite material V;
v) optionally solidifying and/or optionally further process steps.

In process step (iv), in the consolidation, the amount trapped air in the composite material V is reduced and a good connection is established between thermoplastic molding compound A and continuous reinforcing fiber B (especially in the case of continuous reinforcing fibers B embedded layer by layer). It is preferable, after impregnation and consolidation, to obtain a (very substantially) pore-free material composite.

The continuous reinforcing fibers B, as fabric G, may be impregnated and consolidated with the thermoplastic matrix composition M in a single processing step. The composite material V can thus be produced in a particularly efficient manner.

Alternatively, the steps mentioned may be executed in a separate sequence. For example, it is firstly possible to produce layers of reinforcing fibers with differently pretreated continuous reinforcing fibers B, in which case partial impregnation of the continuous reinforcing fibers B with the matrix composition M takes place. This may give rise to partly impregnated layers with continuous reinforcing fibers B having different fiber-matrix adhesion that can be fully impregnated and consolidated in a further step to give a material composite as composite material V.

Before the layers of continuous reinforcing fibers B are laminated with the thermoplastic matrix composition M, at least a portion of the continuous reinforcing fibers B may be subjected to a pretreatment, in the course of which the later fiber-matrix adhesion is influenced. The pretreatment may include, for example, a coating step, an etching step, a heat treatment step or a mechanical surface treatment step. In particular, for example, heating of a portion of the continuous reinforcing fibers B can at least partly remove an adhesion promoter already present.

The layers of continuous reinforcing fibers B (fabric G) may be fully bonded to one another in the production process (laminating). Such composite material mats give optimized strength and stiffness in fiber direction and can be processed further in a particularly advantageous manner.

In a preferred embodiment, the process comprises, as a further process step (v), three-dimensional shaping to give a shaped article T.

This can be effected in any manner, for instance by mechanical shaping by means of a shaping body that may also be an embossed roll. Preference is given to shaping the still-shapeable composite material V in which the thermoplastic molding compound A is still in (partly) molten form. Alternatively or additionally, a cured composite material V may also be cold-formed or reheated prior to forming, such that the thermoplastic molding compound A is in (partly) molten form.

Preferably, at the end of the process, a (largely) solid shaped article T or composite material V is obtained. Preferably, therefore, the process comprises, as a further step (v), the curing of the shaped article T or of the product obtained from step (iv). This step is often also referred to as solidification. The solidification, which generally takes place with removal of heat, typically leads to a ready-to-use shaped article T.

Optionally, the shaped article T, or the composite material V, may still be processed further, for example by the steps of machining, cutting, deburring, polishing and/or colouring.

The process of the invention for producing the composite material V can be effected continuously, semicontinuously or discontinuously.

In a preferred embodiment, the process is conducted as a continuous process, especially as a continuous process, for example, for producing smooth or three-dimensionally embossed films.

Alternatively, the process of the invention for production of the composite material V can be conducted semi- or discontinuously.

Preferably, the process for producing the composite material V of the invention can be conducted by means of an interval hot press.

In a preferred embodiment, the process comprises a step of forming a fin structure. The reason for the improvement in component stiffness by formation of a fin structure is that there is an increase in area moment of inertia. In general, optimal dimensioning of fins includes production-related, esthetic and construction features. The process steps for formation of a fin structure are known to those skilled in the art.

A further aspect of the invention relates to the use of the composite material V of the invention for production of shaped articles T, for example by customary shaping methods, such as press molding, rolling, hot pressing, stamping.

A further aspect of the invention relates to the thermoplastic matrix composition M of the invention as described herein, comprising the thermoplastic molding compound A, and optionally one or more further additives D, and the mixture of the thermoplastic matrix composition M and the at least one particulate inorganic filler C. The thermoplastic matrix composition M of the invention may preferably be provided together with the at least one continuous reinforcing fiber B, preferably in the form of a fabric G, preferably selected from leaves, mats, nonwovens, laid scrims and knits.

If the mixture of the thermoplastic matrix composition M and the at least one particulate inorganic filler C is used, it is possible to obtain composite materials V having particularly high surface quality (low surface corrugation, high gloss).

The present invention is elucidated further by the examples and claims that follow.

### EXAMPLES

Various fiber-reinforced composite materials V were produced from components A1, A2,

B, C1 or C2 and D. The components and methods for characterization thereof are described hereinafter.

### Methods of Characterization

The components used, unless stated otherwise, were characterized by the methods described hereinafter.

The density of the composite materials V was ascertained according to DIN EN ISO 1183-1:2019-09 on test specimens in an immersion method.

The density of the molding compounds A was ascertained according to DIN EN ISO 1183-1:2019-09.

The density of the reinforcing fibers B was ascertained according to ASTM C693.

The density of the filler C is typically ascertained according to DIN-ISO 787/10.

The melt flow rate (MFR) was ascertained according to DIN EN ISO 1133 at 230° C./2.16 kg for polymer A1 or at 190° C./0.325 kg for the polar-functionalized polymer A2.

The melting point Tm was determined by differential scanning calorimetry (DSC) according to DIN EN ISO 11357-3.

The coefficient of linear thermal expansion a (CLTE) was ascertained as the arithmetic average from the values in longitudinal and transverse direction according to ISO 11359-1 and ISO 11359-2.

The average coefficient of thermal volume expansion av was ascertained according to the equation a_{V}=3*α.

Components A, B, C and D used

### Polymer A1 Polyolefin

Propene-ethene copolymer, having a density of 0.898 g/cm³ to 0.900 g/cm³; a melt flow rate MFR (230° C./2.16 kg) of 90 to 110 ml/10 min, usually 100 ml/10 min; a melting point (DSC) of 135° C. to 159° C., a coefficient of thermal expansion α_{A1}=60*10⁻⁶ K⁻¹ to 90*10⁻⁶ K⁻¹, coefficient of thermal volume expansion α_{V,A1}=3*α_{A1}=180*10⁻⁶ K⁻¹ to 270*10⁻⁶ K⁻¹

Polar-Functionalized Polymer A2 Propene Graft Copolymer (PRIEX® 20093 from BYK-Chemie)

Chemically modified propene graft copolymer (white granules) grafted with maleic anhydride (0.15% to 0.25% by weight), having a density of about 0.9 g/cm³. Melt flow rate MFR (190° C./0.325 kg) 9 g/10 min to 13 g/10 min; melting point (DSC) 160° C. to 165° C.

Continuous Reinforcing Fiber B GLASS FIBER (E Glass Fibers from Lange+Ritter GmbH)

Continuous reinforcing fiber B used was a 2/2 glass fiber twill weave having the following properties: Size PP-compatible, basis weight 600 g/m², 1200 tex roving yarn in warp and weft, 25 threads/10 cm in warp and weft direction, coefficient of thermal expansion α_{B}=5*10⁻⁶ K⁻¹ to 6*10⁻⁶ K⁻¹, coefficient of thermal volume expansion α_{V,B}=3*α_{B}=15*10⁻⁶ K⁻¹ to 18*10⁻⁶ K⁻¹ (16.5*10⁻⁶ K⁻¹), density B=2.55 g/ml to 2.58 g/ml (2.57 g/ml).

### Particulate Inorganic Filler C

The following fillers C were used:

C1 CaCO₃ having an average particle size of 35 μm (Omyacarb® 30-AV from OMYA)

Coefficient of thermal expansion α_{C1}=10*10⁻⁶ K⁻¹, coefficient of thermal volume expansion α_{V,C1}=3*α_{C1}=30*10⁻⁶ K⁻¹, density C1=2.3-2.8 g/ml (2.65 g/ml)

C2 Hollow glass beads having an average particle size of 20 μm (iM16K Glass Bubbles from 3M™)

Coefficient of thermal expansion α_{C2}=8*10⁻⁶ K⁻¹ to 9*10⁻⁶ K⁻¹, coefficient of thermal volume expansion α_{V,C2}=3*α_{C2}=24*10⁻⁶ K⁻¹ to 27*10⁻⁶ K⁻¹ (25.5*10⁻⁶ K⁻¹), density C2=0.46 g/ml

Additive D distilled monoglyceride (1-glycerol monostearate, white powder). Dimodan® HP from DuPont Danisco

### Matrix Composition M

The matrix composition M used was a mixture of the thermoplastic molding compound A (comprising polymers A1 and A2) and additive D having the following composition:

TABLE 1
Composition of matrix composition M

| Component | Matrix composition M |
|---|---|
| A1 | 94.2% by wt. |
| A2 | 5.0% by wt. |
| D | 0.8% by wt. |

Matrix composition M is obtained by intensive mixing of components A1, A2 and D in an extruder. Matrix composition M was provided as a powder P(M) and as a film F(M) having a thickness of 67 μm and 135 μm. A filler-containing material composition (M+C) was provided as a film F(M+C) by mixing components A1, A₂, D and C, and forming them to a film having a thickness of 135 μm and 270 μm.

### Production Process

The above-described components were used to produce the composite materials V described in table 1 having a proportion of 40% to 48% by volume of reinforcing fibers B and two layers of the glass fiber twill weave by means of a hot pressing method that will be described. The process for producing the composite materials V comprises the following process steps that are elucidated in detail hereinafter:
i) providing at least one fabric G composed of continuous reinforcing fibers B; the continuous reinforcing fiber is used as roll material, and unrolled within the process;
ii) combining the thermoplastic matrix composition M comprising the thermoplastic ii) molding compound A and the at least one particulate inorganic filler C with the fabric G composed of continuous reinforcing fibers B: the matrix composition M and the continuous reinforcing fibers B are combined in the ways described below at 160-220° C.;
iii) impregnating the continuous reinforcing fiber B with the thermoplastic matrix composition M: the combined layer construction is compressed in an interval hot press; the construction comprising the thermoplastic matrix A, the continuous reinforcing fiber B and the filler C is processed between two steel separation plates. This is done by lowering the press mold onto the press species and lifting it again; the species is moved one place further in the cycle. The compression mold here has a temperature of 200-280° C. The composite is pressed at 1-3 MPa for 5-40 seconds in each operation;
iv) consolidating the composite material V: downstream of the hot compression zone, the composite together with the separation plates is transferred into a colder zone of the compression mold. The temperature here is 80-180° C. The composite is compressed at 1-3 MPa for 5-40 seconds per operation. The matrix material is solidified here, and a finished composite material V is obtained;
v) optionally cooling and optionally further process steps.

### Process Steps i) and ii)

Process step i) comprises the providing of the glass fiber twill weave used in that it is laid out flat.

Process step ii) was conducted in three alternative embodiments that are described hereinafter as process steps ii-a), ii-b) and ii-c).

Process Step ii-a)

The fabric G composed of continuous reinforcing fibers B was provided flat over its full areal extent. The matrix composition M and optionally the filler C, each in the form of powder P(M) and P(C), were applied to the fabric G in one step. The composite was heated up by means of a hot press, so as to establish a bond of the matrix composition M to the fabric G and optionally the filler C. The composite material V was not fully consolidated in this step.

Process Step ii-b)

The fabric G composed of continuous reinforcing fibers B was provided flat over its full areal extent. The filler C was applied to the fabric G in the form of powder P(C). The matrix composition M was applied in the form of a film F(M) to the surface of the fabric G that had been provided with the pulverulent filler C, such that the filler C was enclosed on one or both sides. The composite was heated up by means of a hot press, so as to establish a bond of the matrix composition M to the fabric G and the filler C. The composite material V was not fully consolidated in this step. ps Process Step ii-c)

The fabric G composed of continuous reinforcing fibers B was provided flat over its full areal extent. Films F(M+C), produced from the matrix composition M and the filler C, were used. Layer constructions L composed of the fabric G and the films were produced and pressed in a hot press directly to give the ready-consolidated composite material V. ps Process Step iii)+iv)

The tests that follow were conducted in an interval hot press (manufacturer: Teubert Maschinenbau GmbH, model: HP007) which is capable of producing a composite material from polymer film, melt or powder for quasi-continuous production of fiber-reinforced thermoplastic semifinished products, laminates and sandwich panels.

### Characterization of Process Step ii):

Process step ii) is the combination of the various components. An assessment was made here in each case as to the extent to which caked material occurs in the compression mold in the production process:
1 no caked material on the compression mold
2 little caked material on the compression mold
3 moderate caked material on the compression mold
4 significant caked material on the compression mold

Mechanical characterization of the composite materials

Flexural modulus Er and maximum flexural stress σₘₐₓ were determined on the composite materials produced by the 3-point bending test according to DIN 14125. The values were each measured in 0° direction (in fiber direction) and 90° direction (at right angles to fiber direction). The results are shown in tables 2 to 5.

Characterization of the geometric surface shape of the composite material

The geometric surface shape of the composite materials V produced was determined via the determination of maximum heights S_{Z} by geometric product specification according to DIN EN ISO 25178. The unequal shrinkage characteristics of thermoplastic molding compound A and continuous reinforcing fiber B in the fabric G, without filler C, have the result that the textile fiber architecture shows on the composite surface, called “fiber print through phenomena”. In order to improve the surface quality, i.e. to reduce the showing of the textile fiber architecture and hence to quantitatively minimize the geometric product specification in the form of maximum height S_{Z}, the described fillers C were added to the thermoplastic molding compound A.

In order to measure the areal surface characteristics established, patterns of size 95×70 mm² were repeatedly analyzed and evaluated by means of the optical white light method (phase-stepped diffractometry=PSD). The results are shown in tables 2, 3, 4 and 5.

### Results

Composite materials V with different compositions were produced and characterized in the manner described. The filler contents were chosen such that the volume content of the filler C in the overall matrix composition M (based on the total volume of components M and C) corresponded to a content of about 50% by volume.

TABLE 2
Production and testing of composite materials with different layer structures L
and process step ii-a), examples 1, 2 and comparative example V1.

| Examples | V1 | 1 | 2 |
|---|---|---|---|
| Composition of | | | |
| composite material V | | | |
| Component M | 30 | 16 | 11 |
| (A1/A2/D) [% by wt.] | (28.3/1.5/0.2) | (15.1/0.8/0.1) | (10.4/0.5/0.1) |
| Component B [% by wt.] | 70 | 76 | 54 |
| Component C1 [% by wt.] | — | — | 34 |
| Component C2 [% by wt.] | — | 8 | — |
| Production process | | | |
| Process step ii) | a | A | a |
| Layer construction L^{[1]} | P(M)/G/G/ | P(M) + P(C2)/ | P(M) + P(C1)/ |
| | P(M) | G/G/ | G/G/ |
| | | P(M) + P(C2) | P(M) + P(C1) |
| Caked material on the | 1 | 4 | 3 |
| compression mold | | | |
| Production pressure in | 2 | 2 | 2 |
| process steps | | | |
| iii) and iv) [MPa] | | | |
| Temperature profile in | 210-230-230 | 220-240-240 | 220-240-240 |
| process step iii) [° C.] | | | |
| Temperature profile in | 180-90 | 160-80 | 160-80 |
| process step iv) [° C.] | | | |
| Characterization of | | | |
| composite material V | | | |
| ${}^{[ 2 ]} \frac{volume shrinkage of C}{volume shrinkage of B}$ | — | 0.93 | 1.12 |
| Thickness [mm] | 1.00 | 1.02 | 1.09 |
| Surface corrugation [μm] | 16.4 | 5.7 | 3.4 |
| σₘₐₓ^{[3]} [symbol] 0° | 410 | 345 | 272 |
| 2-layer weave [MPa] | | | |
| σₘₐₓ^{[3]} 90° | 405 | 323 | 238 |
| 2-layer weave [MPa] | | | |

^{[1]}Legend for layer construction: P(M) = matrix composition M in the form of powder; G = fabric G; P(C1) pulverulent filler C1; P(C2) pulverulent filler C2.
${}^{[ 2 ]} \frac{volume shrinkage of C}{volume shrinkage of B} = \frac{\begin{matrix}{∝}_{V , C} \times proportion of C \times \\ density of B in g / ml\end{matrix}}{\begin{matrix}{∝}_{V , B} \times proportion of B \times \\ density of C in g / ml\end{matrix}} = 0.1 to 2$ ^{[3]}Flexural stress σₘₐₓ.

Examples 1 to 6 are inventive; V1 is a comparative example. Examples 1 to 6 show that the inventive introduction of filler C into the composite material V can reduce surface corrugation by four to five times compared to comparative example 1. The surface feel of the composite materials V is thus distinctly improved. The lowest surface corrugation was achieved with a content of 33% by weight of filler C1 or of 8% by weight of filler C2 based on the total weight of the composite material V (cf. examples 3 and 6).

TABLE 3
Production and testing of composite materials with different layer structures L
and process steps ii-b) and ii-c), examples 3 to 6

| Examples | 3 | 4 | 5 | 6 |
|---|---|---|---|---|
| Composition of | | | | |
| composite material V | | | | |
| Component M | 11 | 11 | 14 | 16 |
| (A1/A2/D) | (10.4/0.5/0.1) | (10.4/0.5/0.1) | (13.2/0.7/0.1) | (15.1/0.8/0.1) |
| [% by wt.] | | | | |
| Component B [% by wt.] | 56 | 56 | 77 | 76 |
| Component C1 [% by wt.] | 33 | 33 | — | — |
| Component C2 [% by wt.] | — | — | 9 | 8 |
| Production process | | | | |
| Process step ii) | b | b | c | c |
| Layer construction L^{[1]} | F(M)-135/ | F(M)-67/ | F(M + C2)- | F(M + C2)- |
| | P(C1)/G/G/ | P(C1)/G/ | 270/G/G/ | 135/G/ |
| | P(C1)/ | F(M)-67/ | F(M + C2)-270 | F(M+C2)-135/ |
| | F(M)-135 | F(M)-67/G/ | | F(M + C2)- |
| | | P(C1)/ | | 135/G/ |
| | | F(M)-67 | | F(M + C2)-135 |
| Caked material on the | 2 | 1 | 1 | 1 |
| compression mold | | | | |
| Production pressure in | 2 | 2 | 2 | 2 |
| process steps iii) and iv) | | | | |
| [MPa] | | | | |
| Temperature | 250-280-280 | 250-280-280 | 250-280-280 | 250-280-280 |
| profile in process | | | | |
| step iii) [° C.] | | | | |
| Temperature | 180-90 | 180-90 | 180-90 | 180-90 |
| profile in process | | | | |
| step iv) [° C.] | | | | |
| Characterization of | | | | |
| composite material V | | | | |
| ${}^{[ 2 ]} \frac{volume shrinkage of C}{volume shrinkage of B}$ | 1.03 | 1.03 | 0.97 | 0.88 |
| Thickness [mm] | 1.01 | 1.01 | 0.99 | 0.98 |
| Surface | 3.2 | 3.5 | 3.9 | 3.2 |
| corrugation [μm] | | | | |
| σₘₐₓ^{[3]} [symbol] 0° | 278 | 302 | 231 | 238 |
| 2-layer weave [MPa] | | | | |
| σₘₐₓ^{[3]} 90° | 292 | 257 | 222 | 228 |
| 2-layer weave [MPa] | | | | |

^{[1]}Legend for layer construction: P(M) = matrix composition M in the form of powder; F(M) = matrix composition M in the form of a film; G = fabric G; P(C1) pulverulent filler C1; P(C2) pulverulent filler C2; F(M + C2) = film comprising matrix composition M and filler C2; stated after the film is the respective thickness of the film in μm (67 μm or 135 μm for the films F(M); 135 μm or 270 μm for the films F(M + C2)
${}^{[ 2 ]} \frac{volume shrinkage of C}{volume shrinkage of B} = \frac{\begin{matrix}{∝}_{V , C} \times proportion of C \times \\ density of B in g / ml\end{matrix}}{\begin{matrix}{∝}_{V , B} \times proportion of B \times \\ density of C in g / ml\end{matrix}} = 0.1 to 2$ ^{[3]}Flexural stress σₘₐₓ.

The use of the matrix composition M in the form of films (F(M); cf. examples 3 to 6) rather than powder (P(M), cf. examples 1 and 2) distinctly reduces the occurrence of adhering filler in the compression mold in the production.

TABLE 4
Production of thermoplastic fiber composite plastics with different filler contents,
comparative examples V2 to V4

| Examples | V2 | V3 | V4 |
|---|---|---|---|
| Composition of | | | |
| composite material V | | | |
| Component M | 28.8 | 25.7 | 22.5 |
| (A1/A2/D) [% by wt.] | (27.1/1.5/0.2) | (24.2/1.3/0.2) | (21.2/1.1/0.2) |
| Component B [% by wt.] | 71.2 | 72.4 | 73.7 |
| Component C1 [% by wt.] | — | — | — |
| Component C2 [% by wt.] | — | 1.8 | 3.8 |
| Production process | | | |
| Process step ii) | c | c | c |
| Layer construction L^{[1]} | F(M)-135/G/ | F(M + C2)-135/G/ | F(M + C2)-135/G/ |
| | F(M)-135/ | F(M)-135/ | F(M)-135/ |
| | F(M)-135/G/ | F(M)-135/G/ | F(M + C2)-135/G/ |
| | F(M)-135/ | F(M)-135/ | F(M)-135/ |
| | F(M)-135/G/ | F(M)-135/G/ | F(M)-135/G/ |
| | F(M)-135/ | F(M)-135/ | F(M + C2)-135/ |
| | F(M)-135/G/ | F(M)-135/G/ | F(M)-135/G/ |
| | F(M)-135 | F(M + C2)-135 | F(M + C2)-135 |
| Characterization of | | | |
| composite material V | | | |
| ${}^{[ 2 ]} \frac{volume shrinkage of C}{volume shrinkage of B}$ | — | 0.220 | 0.440 |
| Thickness [mm] | 1.66 | 1.66 | 1.76 |
| Surface corrugation [μm] | 15.9 | 12.2 | 7.8 |
| σₘₐₓ^{[3]} [symbol] 0° | 358 | 358 | 395 |
| 4-layer weave [MPa] | | | |
| σₘₐₓ^{[3]} 90° | 351 | 398 | 406 |
| 4-layer weave [MPa] | | | |

^{[1]}Legend for layer construction: F(M) = matrix composition M in the form of a film; G = fabric G; F(M + C2) = film comprising matrix composition M and filler C2; stated after the film is the respective thickness of the film in μm (67 μm or 135 μm for the films F(M); 135 μm or 270 μm for the films F(M + C2)
${}^{[ 2 ]} \frac{volume shrinkage of C}{volume shrinkage of B} = \frac{\begin{matrix}{∝}_{V , C} \times proportion of C \times \\ density of B in g / ml\end{matrix}}{\begin{matrix}{∝}_{V , B} \times proportion of B \times \\ density of C in g / ml\end{matrix}} = 0.1 to 2$ ^{[3]}Flexural stress σₘₐₓ.

Examples 7 to 10 show how successively increasing the total amount of filler C can achieve a reduction in surface corrugation. In order to half surface corrugation, values of ≥0.44 had to be achieved for the ratio of volume shrinkage C/volume shrinkage B.

TABLE 5
Production of thermoplastic fiber composite plastics with different filler contents,
examples 7 to 10

| Examples | 7 | 8 | 9 | 10 |
|---|---|---|---|---|
| Composition of | | | | |
| composite material V | | | | |
| Component M | 20.9 | 19.2 | 17.5 | 15.7 |
| (A1/A2/D) | (19.7/1.0/0.2) | (18.1/1.0/01) | (16.5/0.9/0.1) | (14.8/0.8/0.1) |
| [% by wt.] | | | | |
| Component B [% by wt.] | 74.4 | 75.1 | 75.8 | 76.5 |
| Component C1 [% by wt.] | — | — | — | — |
| Component C2 [% by wt.] | 4.7 | 5.7 | 6.8 | 7.8 |
| Production process | | | | |
| Process step ii) | c | c | C | c |
| Layer construction L^{[1]} | F(M + C2)- | F(M + C2)- | F(M + C2)- | F(M + C2)- |
| | 135/G/ | 135/G/ | 135/G/ | 135/G/ |
| | F(M)-135/ | F(M + C2)- | F(M + C2)- | F(M + C2)- |
| | F(M + C2)- | 135/ | 135/ | 135/ |
| | 135/G/ | F(M + C2)- | F(M + C2)- | F(M + C2)- |
| | F(M)-67/ | 135/G/ | 135/G/ | 135/G/ |
| | F(M + C2)- | F(M)-135/ | F(M)-67/ | F(M + C2)- |
| | 135/ | F(M)-135/ | F(M + C2)- | 135/ |
| | F(M)-67/G/ | G/ | 135/ | F(M + C2)- |
| | F(M + C2)- | F(M + C2)- | F(M)-67/G/ | 135/G/ |
| | 135/ | 135/ | F(M + C2)- | F(M + C2)- |
| | F(M)-135/G/ | F(M + C2)- | 135/ | 135/ |
| | F(M + C2)- | 135/G/ | F(M + C2)- | F(M + C2)- |
| | 135 | F(M + C2)- | 135/G/ | 135/G/ |
| | | 135 | F(M + C2)-135 | F(M + C2)- |
| | | | | 135 |
| Characterization of | | | | |
| composite material V | | | | |
| ${}^{[ 2 ]} \frac{volume shrinkage of C}{volume shrinkage of B}$ | 0.549 | 0.659 | 0.769 | 0.879 |
| Thickness [mm] | 1.83 | 1.91 | 1.89 | 1.91 |
| Surface corrugation [μm] | 6.6 | 6.8 | 4.8 | 3.4 |
| σₘₐₓ^{[3]} [symbol] 0° | 407 | 371 | 338 | 308 |
| 4-layer weave [MPa] | | | | |
| σₘₐₓ^{[3]} 90° | 388 | 382 | 347 | 291 |
| 4-layer weave [MPa] | | | | |

^{[1]}Legend for layer construction: F(M) = matrix composition M in the form of a film; G = fabric G; F(M + C2) = film comprising matrix composition M and filler C2; stated after the film is the respective thickness of the film in μm (67 μm or 135 μm for the films F(M); 135 μm or 270 μm for the films F(M + C2)
${}^{[ 2 ]} \frac{volume shrinkage of C}{volume shrinkage of B} = \frac{\begin{matrix}{∝}_{V , C} \times proportion of C \times \\ density of B in g / ml\end{matrix}}{\begin{matrix}{∝}_{V , B} \times proportion of B \times \\ density of C in g / ml\end{matrix}} = 0.1 to 2$ ^{[3]}Flexural stress σₘₐₓ.

The mechanical properties of the composite materials V of the invention are also maintained in the case of comparatively low proportions of thermoplastic molding compound A.

1. A fiber-reinforced thermoplastic composite material V comprising:
a) ≥5% to <20% by weight of a thermoplastic molding compound A, wherein the thermoplastic molding compound A comprises at least one thermoplastic polymer A1 and optionally at least one polar-functionalized polymer A2 comprising at least repeat units of at least one functional monomer A2-I;
b) ≥20% to ≤80% by weight of at least one continuous reinforcing fiber B in the form of filament bundles, comprising a multitude of filaments;
c) ≥1% to ≤60% by weight of at least one particulate inorganic filler C; and
d) ≥0% to ≤10% by weight of at least one further additive D;
wherein the at least one particulate inorganic filler C has a coefficient of linear thermal expansion ac (CLTE, measured according to ISO 11359-1 and ISO 11359-2) which is lower than the coefficient of linear thermal expansion α_{A} of the thermoplastic molding compound A (likewise measured according to ISO 11359-1 and ISO 11359-2),
wherein the at least one particulate inorganic filler C has a volume shrinkage which is 0.1 to 2 times the volume shrinkage of the continuous reinforcing fibers B, wherein the volume shrinkage is found from the coefficient of thermal volume expansion α_{V} in 1/K of the respective component multiplied by the proportion by weight of the respective component in the composite material V in % by weight/100 and by the reciprocal density of the respective component in g/cm³, according to the relationship (II):
$$\frac{{∝}_{V , C} \times proportion of C \times density of B in g / ml}{{∝}_{V , B} \times proportion of B \times density of C in g / ml} = 0.1 to 2 \qquad ( II )$$
with:
α_{A,V}=coefficient of thermal volume expansion of component C in 1/K;
proportion of C=proportion by weight of component C in the overall composite material V in % by weight/100;
α_{A,B}=coefficient of thermal volume expansion of component B in 1/K; and
proportion of B=proportion by weight of component B in the overall composite material V in % by weight/100;
wherein the following relationships are applicable:
α_{V,C}=3*α_{C}; and
α_{V,B}=3*α_{B}
with:
α_{A}=average coefficient of linear thermal expansion of component A;
QB=average coefficient of linear thermal expansion of component B; and
α_{C}=average coefficient of linear thermal expansion of component C;
and wherein the figures in % by weight are each based on the overall fiber-reinforced thermoplastic composite material V, and the sum total of components A, B, C, and D is 100% by weight.

2. The fiber-reinforced thermoplastic composite material V of claim 1, wherein the at least one particulate inorganic filler C has a coefficient of thermal expansion α_{C} which is 0.2 to 5 times the coefficient of thermal expansion as of the continuous reinforcing fiber B.

3. The fiber-reinforced thermoplastic composite material V of claim 1, wherein the thermoplastic molding compound A penetrates into the filament bundle of the continuous reinforcing fibers B, but the fillers C penetrate only to an extent of not more than 10% into the filament bundle of the continuous reinforcing fibers B, based on area proportions of a cross section of the filament bundles.

4. The fiber-reinforced thermoplastic composite material V of claim 1, wherein the thermoplastic molding compound A comprises the following constituents:
a-1) 60% to 99% by weight of at least one component A1 of a polymer selected from the group consisting of propene homopolymers, propene copolymers, styrene copolymers, polyamides, and polycarbonates,
a-2) 1% to 40% by weight of a component of a polar-functionalized polymer A2; and
a-3) 0% to 10% by weight of at least one further polymer A3;
wherein polymers A1, A2, and A3 are different than one another, and
wherein the figures in % by weight are each based on the total weight of the thermoplastic molding compound A, and the sum total of components A1, A2, and A3 is 100% by weight.

5. The fiber-reinforced thermoplastic composite material V of claim 1, wherein component A1 is selected from a polymer based on polypropene.

6. The fiber-reinforced thermoplastic composite material V of claim 1at least one of claims 1 to 5, wherein component A1 is a propene-ethene copolymer having a melt mass flow rate (MFR) determined to DIN EN ISO 1133 (230° C./2.16 kg) within a range from 40 g/10 min to 120 g/10 min.

7. The fiber-reinforced thermoplastic composite material V of claim 1, wherein the polar-functionalized polymer A2 comprises at least one repeat unit derived from a monomer selected from the group consisting of maleic anhydride, acrylic acid, N-phenylmaleimide, tert-butyl methacrylate, and glycidyl methacrylate.

8. The fiber-reinforced thermoplastic composite material V of claim 1, wherein the polar-functionalized polymer A2 is a graft copolymer of propene and maleic anhydride with a maleic anhydride content of 0.1% to 5% by weight, based on the total weight of the polar-functionalized polymer A2.

9. The fiber-reinforced thermoplastic composite material V of claim 1, wherein the filler C has an average particle diameter of 1 to 300 μm.

10. The fiber-reinforced thermoplastic composite material V of claim 1, wherein the filler C is selected from the group consisting of glass fillers, mineral fillers, ceramic fillers, and mixtures thereof.

11. The fiber-reinforced thermoplastic composite material V of claim 1, wherein the filler C is selected from the group consisting of hollow glass bodies, calcium carbonate, and mixtures thereof.

12. The fiber-reinforced thermoplastic composite material V of claim 1, wherein the continuous reinforcing fibers B are glass fibers, carbon fibers, aramid fibers, natural fibers, and/or mixed forms of the reinforcing fibers mentioned.

13. The fiber-reinforced thermoplastic composite material V of claim 1, wherein the continuous reinforcing fibers B are glass fibers and/or carbon fibers.

14. A process for producing a fiber-reinforced thermoplastic composite material V of claim 1, wherein the process comprises at least the following process steps:
i) providing the at least one continuous reinforcing fiber B, the at least one thermoplastic molding compound A, the at least one particulate inorganic filler C, and optionally the at least one further additive D;
ii) combining the at least one thermoplastic molding compound A, the at least one particulate inorganic filler C, and optionally the at least one further additive D, with the at least one continuous reinforcing fiber B;
iii) impregnating the continuous reinforcing fiber B with the at least one thermoplastic molding compound A, the at least one inorganic filler C, and optionally the at least one further additive D, in order to obtain a composite material V;
iv) consolidating the resultant composite material V; and
v) optionally solidifying and/or optionally further process steps.

15. A process for producing a fiber-reinforced thermoplastic composite material V of claim 14, wherein the process comprises at least the following process steps:
i-1) providing the at least one continuous reinforcing fiber B, where the surface of the continuous reinforcing fibers B comprises one or more functional groups selected from the group consisting of hydroxy, ester, amino, and silanol groups;
i-2) providing the at least one thermoplastic molding compound A, where the thermoplastic molding compound A comprises the at least one thermoplastic polymer A1 and optionally the at least one polar-functionalized polymer A2 comprising at least repeat units of the at least one functional monomer A2-I;
i-3) providing the at least one particulate inorganic filler C; and
i-4) optionally providing the at least one further additive D;
ii) combining the at least one thermoplastic molding compound A, the at least one particulate inorganic filler C, and optionally the at least one further additive D, with the at least one continuous reinforcing fiber B, where the components are combined at a temperature of at least 160° C. in order to obtain a preliminary fixed construction;
iii) impregnating the continuous reinforcing fiber B with the at least one thermoplastic molding compound A, the at least one particulate inorganic filler C, and optionally the at least one further additive D, in order to obtain a composite material V, where the impregnation is effected at a temperature of at least 180° C.;
iv) consolidating the resultant composite material V; and
v) solidifying and/or optionally further process steps.
